(19) United States
(12) Patent Application Publication
(10) Pub. No.: US 2012/0249415 A1
(43) Pub. Date: Oct. 4, 2012

(54) SERVER, TERMINAL DEVICE, AND GROUPING METHOD

(75) Inventors: Kenji Nakajima, Kawasaki (JP); Naomi Iwayama, Kawasaki (JP); Katsuhiko Akiyama, Kawasaki (JP)

(73) Assignee: Fujitsu Limited, Kawasaki-shi (JP)

(21) Appl. No.: 13/430,103

(22) Filed: Mar. 26, 2012

(30) Foreign Application Priority Data
Mar. 29, 2011 (JP) 2011-073671

(51) Int. Cl. G09G 5/00; G06F 3/01

(52) U.S. Cl. 345/156; 345/1.3

(57) ABSTRACT

A server, which is connected to a plurality of terminal devices, includes a device ID (identification) storage unit configured to store device ID items for identifying the terminal devices; an acquiring unit configured to acquire coordinate information that is input at the terminal devices identified by the device ID items and time information that is input; a positional relationship determining unit configured to determine positional relationships between the terminal devices according to a sequence of coordinates that is input in a manner to cross over the terminal devices, based on the coordinate information and the time information; and a group determining unit configured to extract, from determination results of the positional relationship determining unit, the device ID items identifying the terminal devices that are to be grouped together into a group.

### CROSS-REFERENCE TO RELATED APPLICATION

This patent application is based upon and claims the benefit of priority of the prior Japanese Patent Application No. 2011-073671 filed on Mar. 29, 2011, the entire contents of which are incorporated herein by reference.

### FIELD

The embodiments discussed herein are related to a server for grouping together plural terminal devices, a terminal device, and a grouping method.

### BACKGROUND

In recent years, there is known a system for grouping together a screen of a personal computer (PC) and a screen of a mobile terminal such as a tablet PC, and creating a multi screen to share information and display information in a cooperative manner.

As examples of the grouping procedure in the above system, the following methods are proposed. One method involves registering, in a server, the number of terminal devices to be grouped together in advance, and arranging the terminal devices in accordance with instructions from the server. Another method involves determining the connection status of the terminal devices according to results obtained by detecting the arrangement of the terminal devices. Yet another method involves taking an image of identification numbers being displayed on plural display devices, and detecting the positions of the display devices according to the image that has been taken.
Patent document 1: Japanese Laid-Open Patent Publication No. 2003-271118
Patent document 2: Japanese Laid-Open Patent Publication No. 2003-005947
Patent document 3: Japanese Laid-Open Patent Publication No. 2005-301131
Patent document 4: Japanese Laid-Open Patent Publication No. 2009-301290
Patent document 5: Japanese Laid-Open Patent Publication No. 2009-109671

However, with the method of providing information indicating the number of terminal devices and the arrangement of terminal devices to the server in advance, the following problem arises. That is, the arrangement of terminal devices is specified and the screens are associated to each other according to instructions from the server, and therefore the grouping procedure is complicated. Furthermore, the number of terminal devices and the arrangement of terminal devices need to be reported to the server in advance, and therefore users of the terminals cannot freely change the positions of the terminals. Furthermore, with the method of detecting the arrangement positions of the terminals, physical detecting means such as a proximity sensor and a camera are used, which leads to an increase in cost.

As described above, with conventional systems, it has been difficult for users of terminals to easily group together the terminals.

### SUMMARY

According to an aspect of the present invention, a server, which is connected to a plurality of terminal devices, includes a device ID (identification) storage unit configured to store device ID items for identifying the terminal devices; an acquiring unit configured to acquire coordinate information that is input at the terminal devices identified by the device ID items and time information that is input; a positional relationship determining unit configured to determine positional relationships between the terminal devices according to a sequence of coordinates that is input in a manner to cross over the terminal devices, based on the coordinate information and the time information; and a group determining unit configured to extract, from determination results of the positional relationship determining unit, the device ID items identifying the terminal devices that are to be grouped together into a group.

The object and advantages of the invention will be realized and attained by means of the elements and combinations particularly pointed out in the appended claims. It is to be understood that both the foregoing general description and the following detailed description are exemplary and explanatory and are not restrictive of the invention as claimed.

### BRIEF DESCRIPTION OF THE DRAWINGS

FIG. 1 illustrates a system configuration of a grouping system according to a first embodiment.

FIG. 2 illustrates a hardware configuration of the grouping server;

FIG. 3 illustrates a hardware configuration of a terminal device;

FIG. 4 illustrates an example of an arrangement of terminal devices in a grouping process according to the first embodiment;

FIG. 5 is a flowchart of operational procedures of the user when grouping the terminal devices;

FIGS. 6A and 6B are first diagrams for describing the operational procedures for the grouping process;

FIGS. 7A and 7B are second diagrams for describing the operational procedures for the grouping process;

FIG. 8 illustrates functional configurations of a grouping server and a terminal device according to the first embodiment;

FIG. 9 is a flowchart of operations of the terminal device according to the first embodiment;

FIG. 10 is a flowchart of operations of the grouping server according to the first embodiment;

FIG. 11 is a flowchart of a process performed by a group determining unit according to the first embodiment;

FIGS. 12A and 12B illustrate how coordinate information is input to the terminal devices according to the first embodiment;

FIG. 13 illustrates an example of group information according to the first embodiment;

FIGS. 14A through 14D are first diagrams illustrating examples of determination-use information according to the first embodiment;

FIGS. 15A through 15D are second diagrams illustrating examples of determination-use information according to the first embodiment;

FIGS. 16A through 16D are first diagrams for describing a process performed by a target coordinate point extracting unit according to the first embodiment;

FIGS. 17A through 17D are second diagrams for describing the process performed by the target coordinate point extracting unit according to the first embodiment;

FIG. 18 is a first diagram for describing the processes of a target coordinate point position determining unit and a coordinate point determining unit according to the first embodiment;

FIG. 19 is a second diagram for describing the processes of the target coordinate point position determining unit and the coordinate point determining unit according to the first embodiment;

FIG. 20 illustrates an example of group information to which group determination results are applied according to the first embodiment;

FIG. 21 illustrates an example of an arrangement of terminal devices in a grouping process according to a second embodiment;

FIG. 22 illustrates functional configurations of a grouping server and a terminal device according to the second embodiment;

FIG. 23 is for describing directions in the second embodiment;

FIG. 24 is a flowchart of a process performed by a group determining unit according to the second embodiment;

FIG. 25 illustrates how coordinate information is input to terminal devices according to the second embodiment;

FIGS. 26A through 26D illustrate determination-use information according to the second embodiment;

FIGS. 27A through 27D are diagrams for describing the process performed by the target coordinate point extracting unit according to the second embodiment;

FIGS. 28A through 28D are for describing the process of a direction determining unit and a coordinate converting unit according to the second embodiment;

FIG. 29 indicates an example of group information to which group determination results are applied according to the second embodiment;

FIG. 30 illustrates an example of an arrangement of terminal devices in a grouping process according to a third embodiment;

FIG. 31 illustrates functional configurations of a grouping server and a terminal device according to the third embodiment;

FIG. 32 illustrates an example of screen information according to the third embodiment;

FIG. 33 is a flowchart of a process performed by a group determining unit according to the third embodiment;

FIG. 34 illustrates coordinate conversion according to the third embodiment;

FIG. 35 illustrates functional configurations of a grouping server and a terminal device according to a fourth embodiment;

FIG. 36 is for describing the operation of estimating the boundary of terminal devices;

FIG. 37 is a first diagram of an example of other arrangements of the terminal devices;

FIGS. 38A through 38C are second diagrams of examples of other arrangements of the terminal devices; and

FIGS. 39A through 39C are third diagrams of examples of other arrangements of the terminal devices.

### DESCRIPTION OF EMBODIMENTS

### First Embodiment

A description is given of a first embodiment of the present invention with reference to drawings.

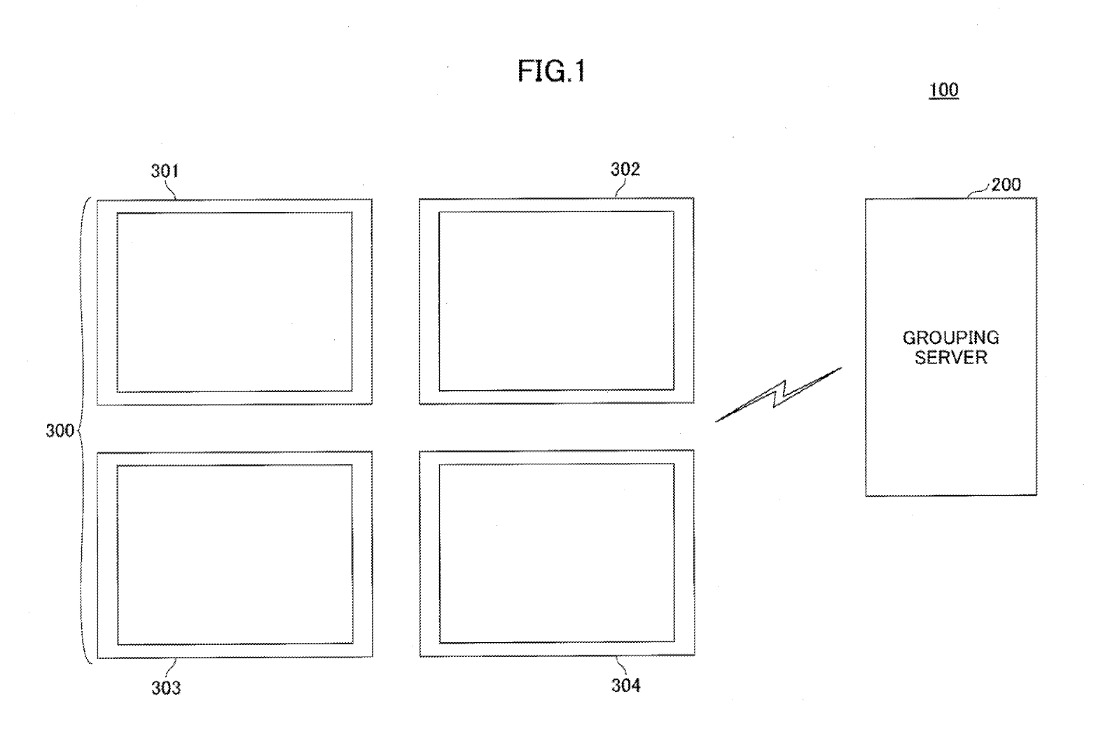

FIG. 1 illustrates a system configuration of a grouping system according to the first embodiment.

A grouping system 100 according to the present invention includes a grouping server 200 and terminal devices 300. In the grouping system 100, the grouping server 200 and the terminal devices 300 are connected so that data communications can be performed. The grouping server 200 and the terminal devices 300 may be connected by, for example, wireless LAN (wireless Local Area Network) or a mobile phone communication network.

In the grouping system 100 according to the present embodiment, the terminal devices 300 include plural terminal devices. In the present embodiment, it is assumed that the terminal devices 300 include a terminal device 301, a terminal device 302, a terminal device 303, and a terminal device 304. In the following description, when the terminal devices 301 through 304 do not need to be distinguished from each other, they are described as the terminal devices 300.

In the grouping system 100 according to the present embodiment, the grouping server 200 groups and ungroups the terminal devices 300. In the present embodiment, grouping means to register the terminal devices 300 as one group in the grouping server 200. The terminal devices 300 that have been grouped together may share various information items.

The grouping server 200 according to the present embodiment is implemented by a computer device in which a grouping program is installed. Furthermore, the terminal device 300 according to the present embodiment is a computer device in which a grouping request program is installed. The terminal device 300 according to the present embodiment is a computer device having a screen with which coordinate values may be input. For example, the terminal device 300 is implemented by a slate type PC in which a display screen and an input device are integrated.

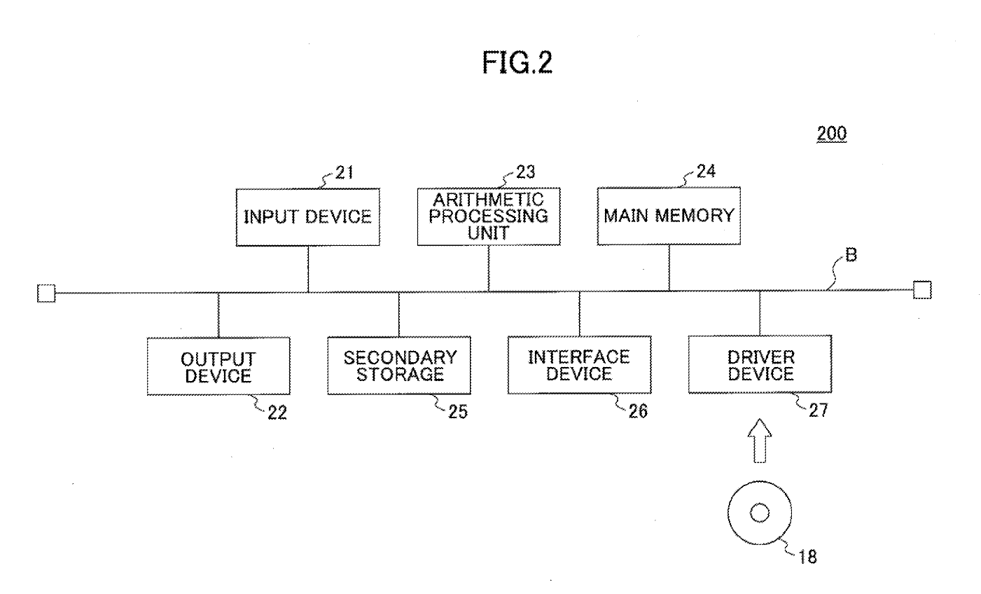

A description is given of a hardware configuration of the grouping server 200 according to the present embodiment. FIG. 2 illustrates a hardware configuration of the grouping server 200. The grouping server 200 includes an input device 21, an output device 22, an arithmetic processing unit 23, a main memory 24, a secondary storage 25, an interface device 26, and a driver device 27, which are interconnected by a bus B.

The input device 21, the output device 22, the arithmetic processing unit 23, the main memory 24, the secondary storage 25, the interface device 26, and the driver device 27, which are interconnected by the bus B, can exchange data under the control of the arithmetic processing unit 23. The arithmetic processing unit 23 is a central processing device (CPU) that controls the overall operations of the grouping server 200.

The interface device 26 receives data from another computer, and passes the contents of the received data to the arithmetic processing unit 23. Furthermore, the interface device 26 sends data to another computer according to instructions from the arithmetic processing unit 23.

The secondary storage 25 stores a grouping program for executing at least a grouping process, which is one of the programs for implementing functions of the grouping server 200.

In the grouping server 200, the arithmetic processing unit 23 reads the grouping program from the secondary storage 25 and executes the grouping program, to implement a function of the grouping server 200. The grouping program may be stored in the arithmetic processing unit 23 and the accessible main memory 24. The input device 21 receives data input under the control of the arithmetic processing unit 23. The grouping program may be recorded in a recording medium 18 that is readable by the grouping server 200.

The recording medium 18, readable by the grouping server 200, may be a magnetic recording medium, an optical disk, a magneto-optical recording medium, or a semiconductor memory. The magnetic recording medium may be a HDD, a flexible disk (FD), and a magnetic tape (MT). The optical disk may be a DVD (Digital Versatile Disc), a DVD-RAM, a CD-ROM (Compact Disc—Read Only Memory), and a CD-R (Recordable)/RW (ReWritable). The magneto-optical recording medium may be a MO (magneto-optical disk). To distribute a grouping program, a portable recording medium 18 such as a DVD or a CD-ROM in which the grouping program is recorded, may be sold.

The grouping server 200 executing the grouping program reads, by the driver device 27, the grouping program from the recording medium 18 in which the grouping program is recorded. The arithmetic processing unit 23 stores the read grouping program in the main memory 24 or the secondary storage 25.

The grouping server 200 reads the grouping program from the main memory 24 or the secondary storage 25, and executes a process according to the grouping program.

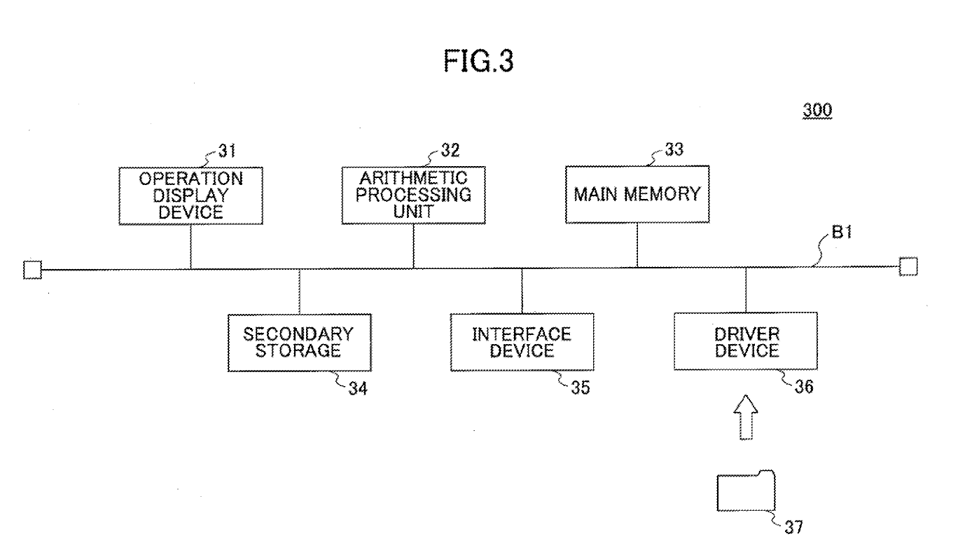

Next, a description is given of a hardware configuration of the terminal device 300 according to the present embodiment. FIG. 3 illustrates a hardware configuration of the terminal device 300. The terminal device 300 includes an operation display device 31, an arithmetic processing unit 32, a main memory 33, a secondary storage 34, an interface device 35, and a driver device 36, which are interconnected by a bus B1.

The operation display device 31, the arithmetic processing unit 32, the main memory 33, the secondary storage 34, the interface device 35, and the driver device 36, which are interconnected by the bus B1, can exchange data under the control of the arithmetic processing unit 32. The arithmetic processing unit 32 is a central processing device (CPU) that controls the overall operations of the terminal device 300.

The interface device 35 receives data from another computer, and passes the contents of the received data to the arithmetic processing unit 32. Furthermore, the interface device 35 sends data to another computer according to instructions from the arithmetic processing unit 32.

The secondary storage 34 stores a grouping request program for executing at least a grouping process, which is one of the programs for implementing functions of the terminal device 300.

In the terminal device 300, the arithmetic processing unit 32 reads the grouping request program from the secondary storage 34 and executes the grouping request program, to implement a function of the terminal device 300. The grouping request program may be stored in the arithmetic processing unit 32 and the main memory 33 which is accessible. The operation display device 31 receives data input under the control of the arithmetic processing unit 32. The operation display device 31 is an operation component having, for example, a touch pad type display function, in which coordinates can be input with a pointing device. The grouping request program may be recorded in a recording medium 37 that is readable by the terminal device 300.

The recording medium 37 readable by the terminal device 300 is, for example, an SD memory card. To distribute a grouping request program, a portable recording medium 37 in which the grouping request program is recorded, may be sold.

The terminal device 300 executing the grouping request program reads, by the driver device 36, the grouping request program from the recording medium 37 in which the grouping request program is recorded. The arithmetic processing unit 32 stores the read grouping request program in the main memory 33 or the secondary storage 34.

The terminal device 300 reads the grouping request program from the main memory 33 or the secondary storage 34, and executes a process according to the grouping request program.

A description is given of the process of grouping the terminal devices 300 in the grouping system 100 according to the present embodiment.

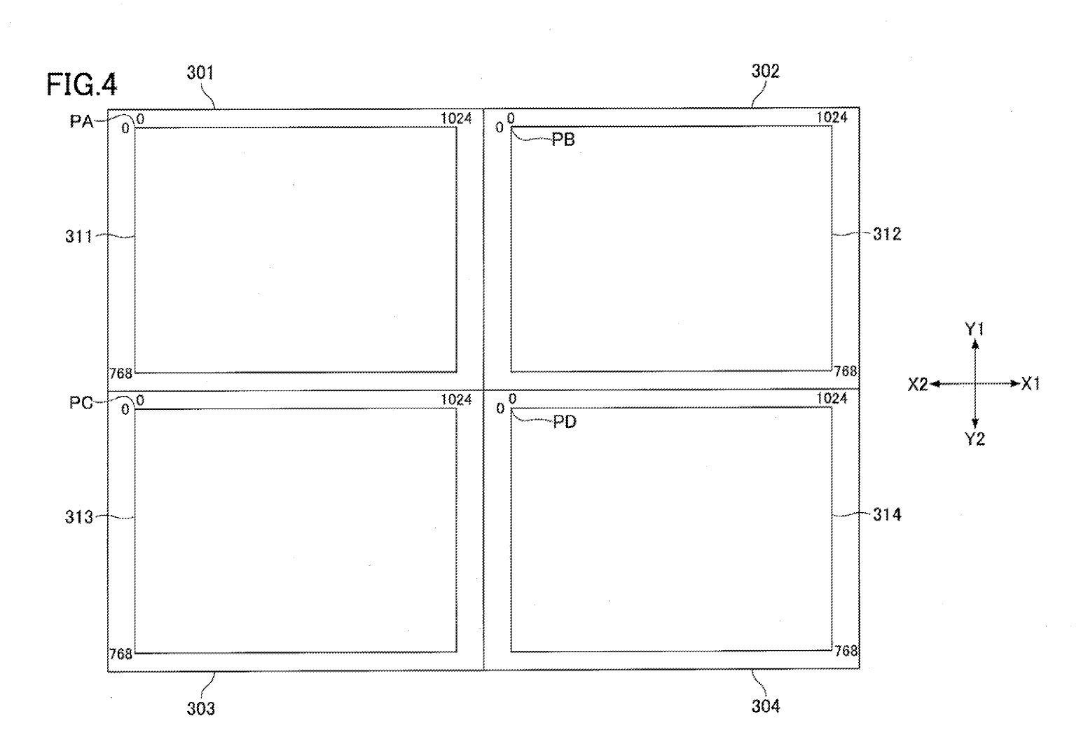

FIG. 4 illustrates an example of an arrangement of terminal devices in a grouping process according to the first embodiment. In FIG. 4, when grouping together four terminal devices 300 into one group, all four terminal devices 300 are arranged to be facing the same direction.

An arrangement of facing the same direction means the following. Assuming that the Y1 direction is the top direction, the Y2 direction is the bottom direction, the X1 direction is the right direction, and the X2 direction is the left direction, the origins PA, PB, PC, and PD in the coordinate systems expressing display areas 311 through 314 of the terminal devices 301 through 304, are respectively located at the top left positions in the display areas 311 through 314.

In the present embodiment, a description is given of a grouping process when the terminal devices 300 are arranged as illustrated in FIG. 4.

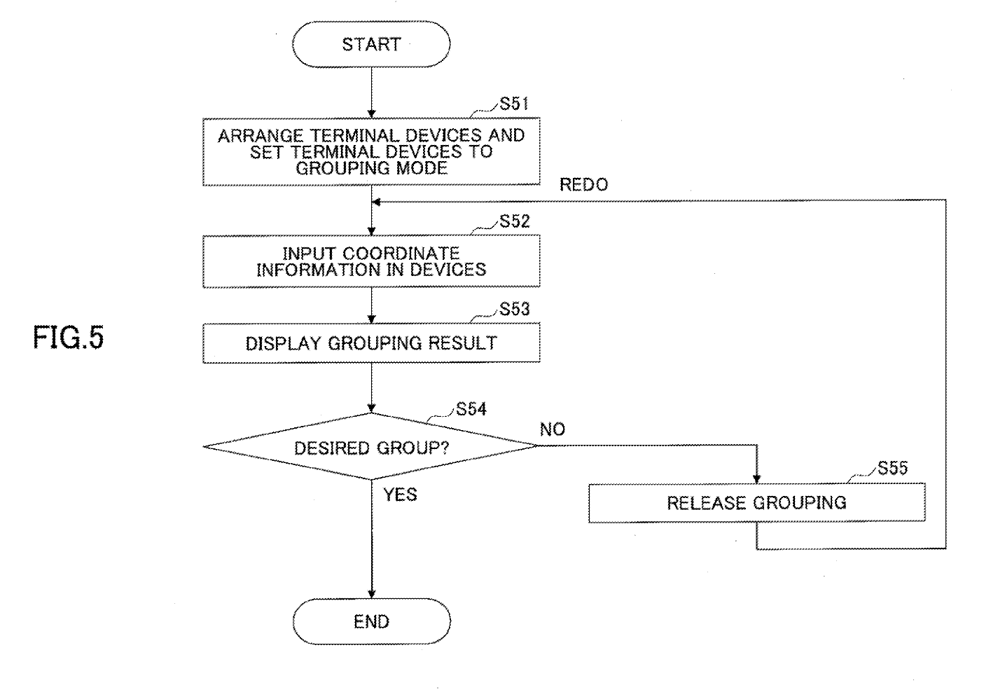

FIG. 5 is a flowchart of operational procedures of the user when grouping the terminal devices. The user arranges the four terminal devices 301 through 304 in the arrangement as illustrated in FIG. 4, and sets the terminal devices 301 through 304 to a grouping mode by an operation described below (step S51). The terminal devices 301 through 304 may be set to the grouping mode before being arranged.

Next, the user inputs coordinate information in the display areas 311 through 314 in a manner as to cross the boundaries of the arranged terminal devices 301 through 304 (step S52). For example, the coordinate information is input by handwriting the coordinate information into the display areas 311 through 314. Details of inputting the coordinate information are given below. The handwriting may be, for example, lines that are drawn when a pointing device or the user's finger contacts the display areas 311 through 314. Furthermore, when display areas 311 through 314 have a non-contact type coordinate input function by which coordinate information can be input without contacting the display areas, the handwriting may be lines drawn without contacting the display areas 311 through 314.

When the grouping server 200 groups the terminal devices 301 through 304 and the grouping results are displayed (step S53), the user confirms whether the desired group is formed (step S54). In step S54, when the desired group is not formed, the user inputs an operation to perform the grouping once again (step S55), and the process returns to step S52. When the desired group is formed at step S54, the operational procedures for the grouping process end.

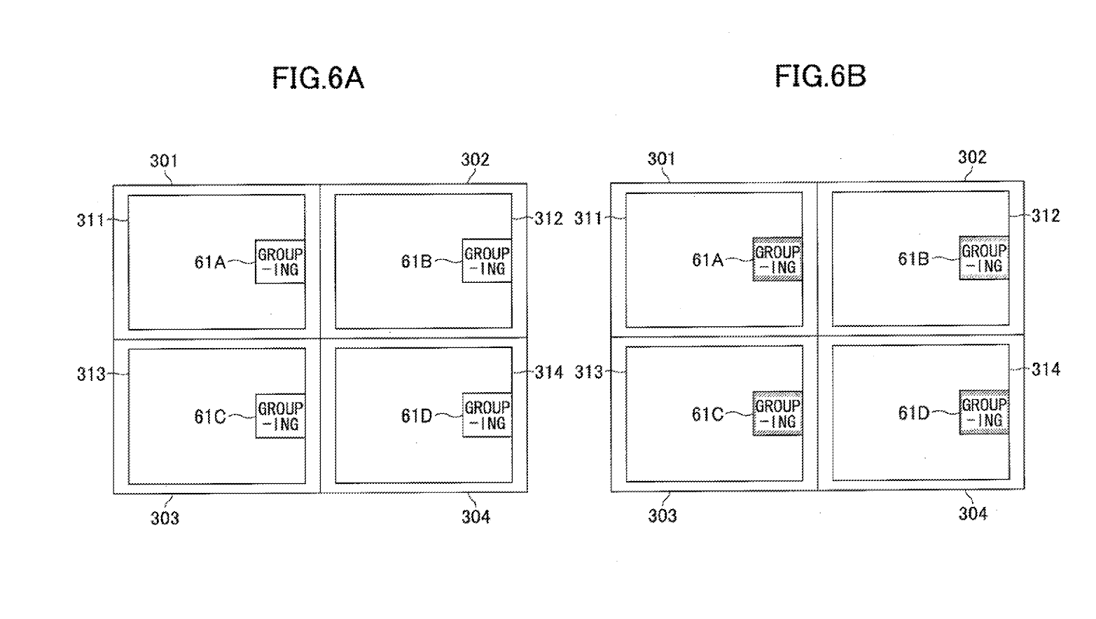

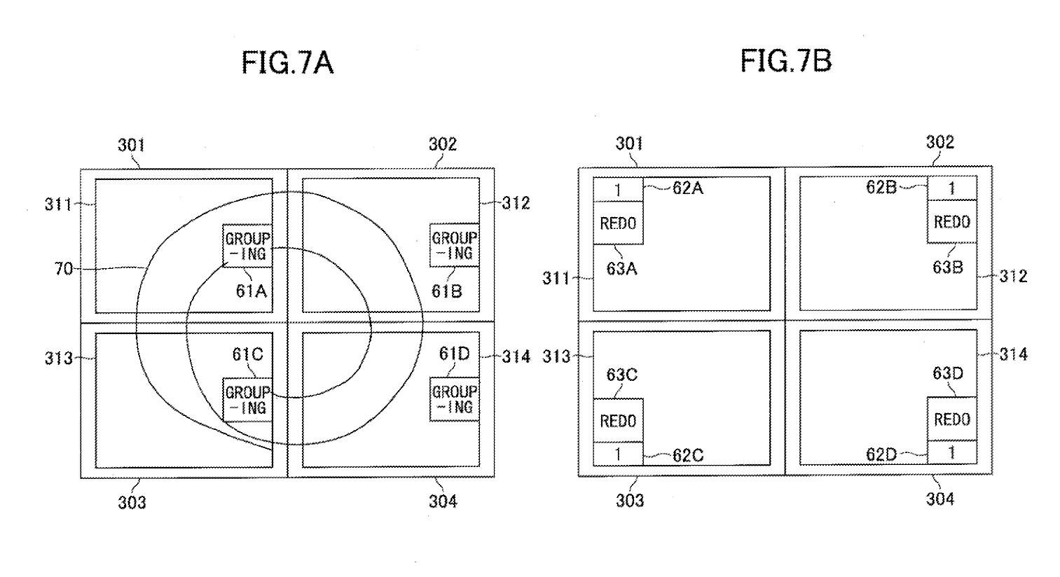

A detailed description is given of the operational procedures for the grouping process, with reference to FIGS. 6A through 7B. FIGS. 6A and 6B are first diagrams for describing the operational procedures for the grouping process. FIGS. 6A and 6B correspond to step S51 of FIG. 5. FIG. 6A illustrates a state where the terminal devices 301 through 304 are arranged, and FIG. 6B illustrates a state where the terminal devices 301 through 304 are set to the grouping mode.

In FIG. 6A, the terminal devices 301 through 304 display, in the display areas 311 through 314, operation buttons 61A through 61D for setting the grouping mode. When the operation buttons 61A through 61D in FIG. 6B are pushed, the terminal devices 301 through 304 activate a grouping request program, and make a grouping request.

FIGS. 7A and 7B are second diagrams for describing the operational procedures for the grouping process. FIGS. 7A and 7B correspond to steps S52 through S55 of FIG. 5. FIG. 7A illustrates a state where handwriting 70 is drawn in the display areas 311 through 314. FIG. 7B illustrates a state where the grouped results are displayed.

In the present embodiment, when the handwriting 70 illustrated in FIG. 7A is drawn, the coordinate information of the handwriting 70 is input to the terminal devices 301 through 304. In the present embodiment, for example, a pointing device or a user's finger is used to draw, in the display areas 311 through 314, the handwriting 70 including circles or spiral patterns crossing over the terminal devices 301 through 304. Accordingly, coordinate information is input to the terminal devices 301 through 304.

The input coordinate information is sent to the grouping server 200, to be used for grouping the terminal devices 301 through 304. The handwriting 70 of the present embodiment is a spiral pattern; however, the present invention is not so limited. The handwriting 70 is to be drawn to cross over the terminal devices that are to be grouped together.

When the terminal devices 301 through 304 are grouped together, a group ID for identifying the group is displayed in areas 62A through 62D of the display areas 311 through 314 as illustrated in FIG. 7B. Furthermore, the terminal devices 301 through 304 display, in the display areas 311 through 314, operations buttons 63A through 63D for instructing to redo the grouping process in case the terminal devices are not grouped into the desired group.

Next, a description is given of functional configurations of the grouping server 200 and the terminal device 300 in the grouping system 100 according to the present embodiment.

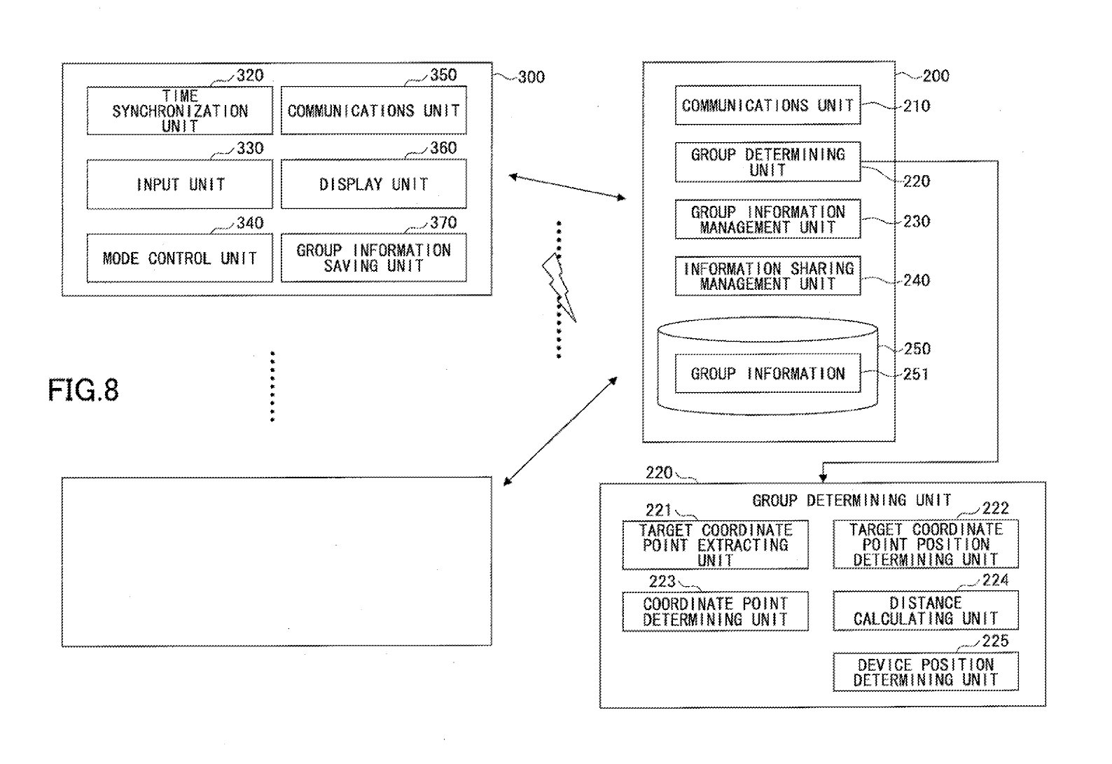

FIG. 8 illustrates functional configurations of the grouping server 200 and the terminal device 300 according to the first embodiment.

The grouping server 200 according to the present embodiment includes a communications unit 210, a group determining unit 220, a group information management unit 230, an information sharing management unit 240, and a group information database 250.

The communications unit 210 is used for communications between the grouping server 200 and the terminal device 300. The group determining unit 220 determines the number and arrangement of terminal devices 300 that are to be grouped together, based on the determination-use information sent from the terminal devices 300. Details of the determination-use information and the group determining unit 220 are given below.

The group information management unit 230 manages group information 251 described below. Specifically, when the group determining unit 220 determines the group, the group information management unit 230 applies the determination results to the group information 251 and stores the group information 251 in the group information database 250. The information sharing management unit 240 manages information to be shared by the terminal devices 300 that have been grouped together. For example, when a request to acquire information is received from the terminal device 301 among the terminal devices 301 through 304 that have been grouped together, the information sharing management unit 240 according to the present embodiment sends, at once, the information corresponding to the request to all of the terminal devices 301 through 304 forming one group.

The group information database 250 includes a device ID storage unit storing device IDs for identifying the terminal devices 300, and the group information 251 including the device IDs is stored in the device ID storage unit. The group information 251 includes the device ID, a group ID for identifying the group to which the terminal device 300 belongs, and information indicating the position of the terminal device 300 in the group. The group information database 250 according to the present embodiment may be constituted by the main memory 24 and/or the secondary storage 25 of the grouping server 200, or may be provided outside the grouping server 200.

Details of the group determining unit 220 are given below.

The group determining unit 220 according to the present embodiment includes a target coordinate point extracting unit 221, a target coordinate point position determining unit 222, a coordinate point determining unit 223, a distance calculating unit 224, and a device position determining unit 225.

The target coordinate point extracting unit 221 extracts coordinate points used for determining the group (hereinafter, “target coordinate points”) from the coordinate information of the handwriting 70 acquired from the terminal devices 300 via the communications unit 210. In the present embodiment, the points positioned along the edges of the display areas 311 through 314 and the starting point and ending point of the handwriting 70 are extracted. The target coordinate point position determining unit 222 determines whether the extracted coordinate points are positioned on any of the top, bottom, left, or right sides of the terminal devices 300.

The coordinate point determining unit 223 determines the pairs of coordinate points whose distances (inter-coordinate point distance) are to be calculated, from among the extracted target coordinate points. The distance calculating unit 224 calculates the inter-coordinate point distance for the determined pairs. The device position determining unit 225 determines the positions of the terminal devices 300 based on the distances calculated by the distance calculating unit 224. Details of the processes performed by the units in the grouping server 200 are given below.

Next, a description is given of the terminal device 300 according to the present embodiment.

The terminal device 300 according to the present embodiment includes a time synchronization unit 320, an input unit 330, a mode control unit 340, a communications unit 350, a display unit 360, and a group information saving unit 370. The time synchronization unit 320 synchronizes the time of the clock function of the terminal device 300 with that of the grouping server 200. The input unit 330 causes a display area 311 of the operation display device 31 to function as an input unit for inputting information. In the present embodiment, when a pointing device or a user's finger touches the display area 311, the input unit 330 inputs the coordinate information of the touched position.

The mode control unit 340 controls the operation of making a grouping request to the grouping server 200. In the present embodiment, for example, when the operation buttons 61A through 61D are operated, the mode control unit 340 may activate the grouping request program and set the terminal devices 300 to the grouping mode, and send a grouping request to the grouping server 200.

The communications unit 350 performs communications with other terminal devices 300 and the grouping server 200. The display unit 360 causes the display area 311 of the operation display device 31 to function as a display unit for displaying information. The group information saving unit 370 saves self group information (group information relevant to the terminal device 300 itself). The group information saving unit 370 is constituted by the main memory 33 and/or the secondary storage 34. Self group information includes a group ID for identifying the group to which the terminal device 300 belongs and device IDs of the terminal devices 300 included in the same group as the terminal device 300 itself. Furthermore, the self group information is obtained by extracting, from the group information 251, the group information of the group including the terminal device 300.

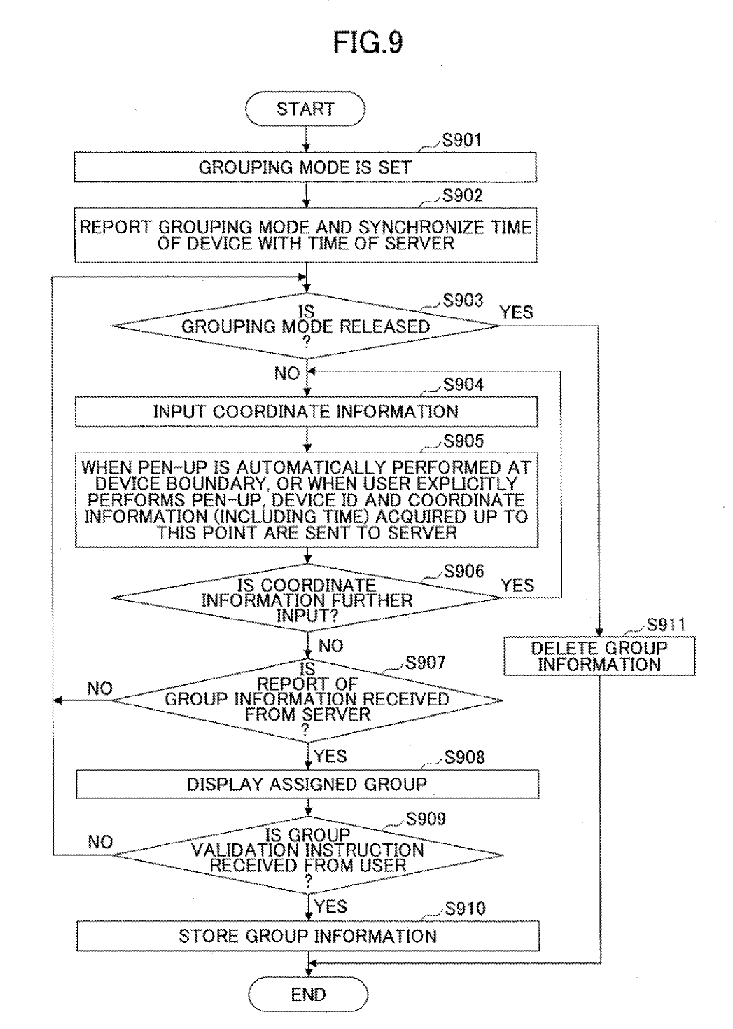

A description is given of operations of the terminal device 300 in the grouping system 100 according to the present embodiment. FIG. 9 is a flowchart of operations of the terminal device 300 according to the first embodiment.

In the terminal device 300 of the present embodiment, when a grouping mode is set as an operation button is pushed, the mode control unit 340 sends a grouping request to the grouping server 200 (step S901). Next, the time synchronization unit 320 reports the grouping request to the grouping server 200, and also synchronizes the time of the clock function of the terminal device 300 with the time of the clock function of the grouping server 200 (step S902). In the present embodiment, the time synchronization unit 320 may send the device ID of the terminal device 300 to the grouping server 200, together with the report of the grouping request. The grouping server 200 may store the received device IDs in the group information database 250 as information included in the group information 251.

Next, the mode control unit 340 determines whether the grouping mode has been released (step S903). In step S903, when the grouping mode is not released, the input unit 330 receives input of coordinate information of the handwriting 70 drawn in the operation display device 31 (step S904).

Next, when input of the coordinate information ends, the terminal device 300 sends, to the grouping server 200 by the communications unit 350, the device ID of itself, the acquired coordinate information, and time information indicating the time when the coordinate information has been input (step S905). In the following description, the information including the device ID, the coordinate information, and the time information is referred to as determination-use information. Furthermore, the end of the input of coordinate information is referred to as pen-up. Pen-up means, for example, that the pointing device or the user's finger does not contact the operation display device 31 anymore. Specifically, pen-up means when the handwriting 70 ends and when the handwriting 70 crosses over plural terminal devices 300.

Furthermore, pen-down means that the pointing device or the user's finger contacts the operation display device 31 and input of coordinate information starts. Pen-down means, for example, when the handwriting 70 starts and when the handwriting 70 is continuously drawn after crossing over to another terminal device 300.

Next, in the terminal device 300, the input unit 330 determines whether the coordinate information is being further input (step S906). When coordinate information is being input at step S906, the process returns to step S904. When coordinate information is not being input at step S906, the mode control unit 340 determines whether self group information, indicating that grouping has been performed (including the self device) by the grouping server 200, is reported from the grouping server 200 (step S907).

When self group information is not reported at step S907, the process returns to step S903. When self group information is reported at step S907, the display unit 360 causes the operation display device 31 to display the group ID indicating a group assigned to the terminal device 300 according to the self group information (step S908).

Next, the mode control unit 340 determines whether a group validation instruction to validate the group has been received (step S909). In step S909, when a group validation instruction has not been received, the process returns to step S903. In step S909, when a group validation instruction has been received, the group information saving unit 370 saves the self group information (step S910), and the process ends. Furthermore, in step S903, when the grouping mode is released, the terminal device 300 deletes the self group information saved in the group information saving unit 370 (step S911), and the process ends.

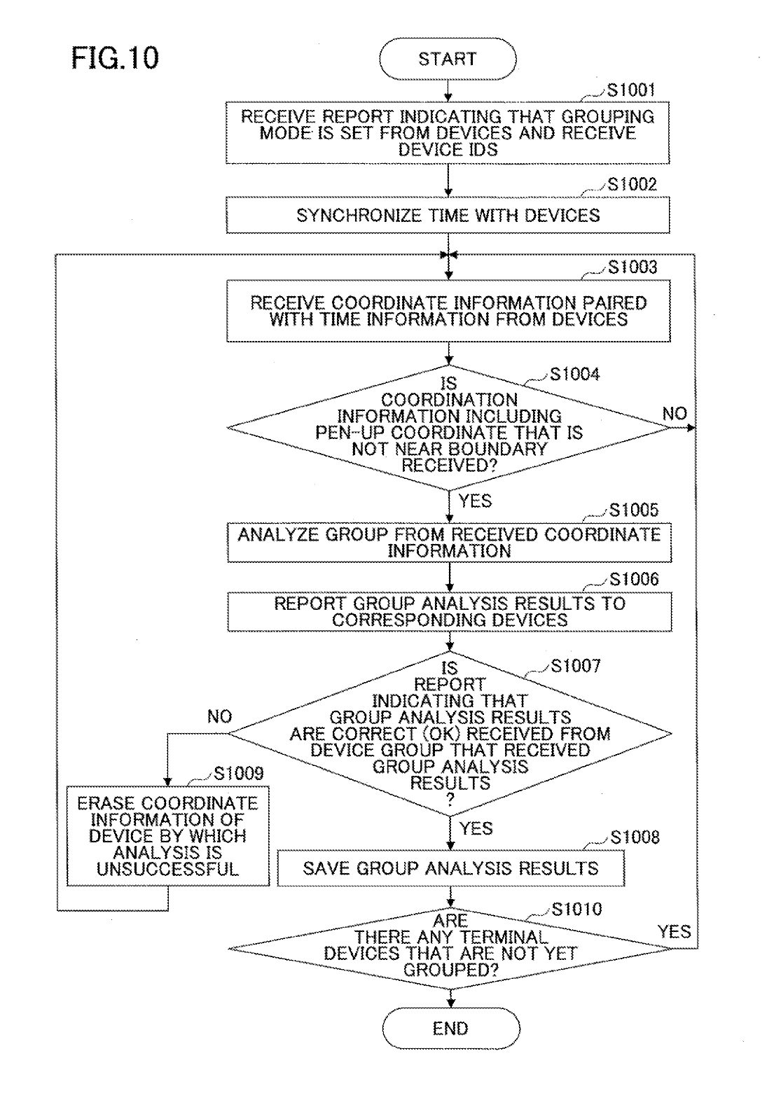

Next, a description is given of the operation of the grouping server 200 in the grouping system 100 according to the present embodiment. FIG. 10 is a flowchart of operations of the grouping server 200 according to the first embodiment.

The grouping server 200 receives, by the communications unit 210, a report indicating that the grouping mode has been set from the terminal device 300, and the device ID of the terminal device 300 that sent the report (step S1001). Next, the group determining unit 220 synchronizes the time of the grouping server 200 with the time of the terminal device 300 from which the device ID has been received (step S1002).

Next, the communications unit 210 receives, from the terminal device 300, determination-use information including the device ID, coordinate information, and time information (step S1003). The received determination-use information is temporarily stored in the main memory 24 and/or the secondary storage 25.

Next, the group determining unit 220 determines whether the coordinate value when pen-up is performed (pen-up coordinate that is not near boundary) is included in the coordinate information in the received determination-use information (step S1004). This step is to find the end of the handwriting input operation. Next, the group determining unit 220 analyzes the group of terminal devices 300 using the coordinate information (step S1005). Details of analyzing the group are given below.

Next, the communications unit 210 reports the self group information as analysis results of group to the corresponding terminal devices 300 (step S1006). Next, the group determining unit 220 determines whether the communications unit 210 has received reports indicating that the group analysis results are correct, from the corresponding terminal devices 300 (step S1007). In step S1007, when the reports have been received, the group information management unit 230 saves the group analysis results as the group information 251 in the group information database 250 (step S1008). In step S1007, when the reports have not been received, the group information management unit 230 erases the determination-use information of the terminal devices 300 for which analysis has been unsuccessful, from the main memory 24 and/or the secondary storage (step S1009).

After step S1008, the group determining unit 220 determines whether there are any terminal devices 300 that are not yet grouped (step S1010). In step S1010, when there is a terminal device 300 that is not yet grouped, the process returns to step S1003. In step S1010, when there are no terminal devices 300 that are not yet grouped, the grouping server 200 ends the grouping process.

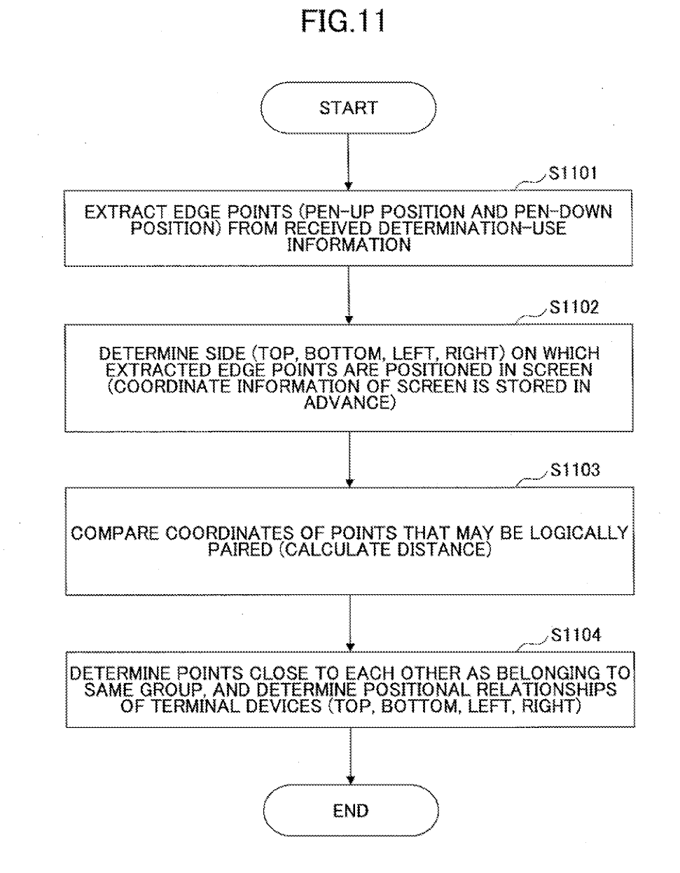

With reference to FIG. 11, a detailed description is given of the operation of analyzing the group at step S1005 of FIG. 10.

FIG. 11 is a flowchart of a process performed by the group determining unit 220 according to the first embodiment. The group determining unit 220 of the grouping server 200 extracts, by the target coordinate point extracting unit 221, determination-use information relevant to the edge points from the received determination-use information (step S1101). Edge points are the points where pen-up and pen-down are performed.

Next, the target coordinate point position determining unit 222 determines where the extracted edge points are positioned in the display areas (step S1102). The grouping server 200 according to the present embodiment stores, in advance, information relevant to the display areas of the operation display devices 31 of the terminal devices 300. Information relevant to the display areas means, for example, the sizes of the display areas and the number of pixels in the display areas.

Next, the coordinate point determining unit 223 pairs together the coordinate points that may form the same group based on the time information of the edge points, and the distance calculating unit 224 calculates the distance between the coordinate points that have been paired together (step S1103). Specifically, for example, the edge point positioned on the right side of the display area 311 and the edge point positioned on the left side of the display area 312 in FIG. 7A may form the same group. In this case, the coordinate point determining unit 223 determines whether these two edge points may form a pair based on the Y coordinate values of the two edge points and the time information when the coordinate values of the two edge points have been input. When it is determined that these two edge points may form a pair, the distance calculating unit 224 calculates the distance between the two points. One of the edge points in the pair is the point where pen-up is performed, and the other one of the edge points is the point where pen-down is performed.

By pairing together the point where pen-up is performed and the point where pen-down is performed, the parts of the handwriting 70 crossing over plural terminal devices 300 can be recognized.

Next, the device position determining unit 225 groups together the edge points whose distances between coordinate points are within a predetermined range, and determines the top, bottom, left, and right positions of the terminal devices 300 (step S1104).

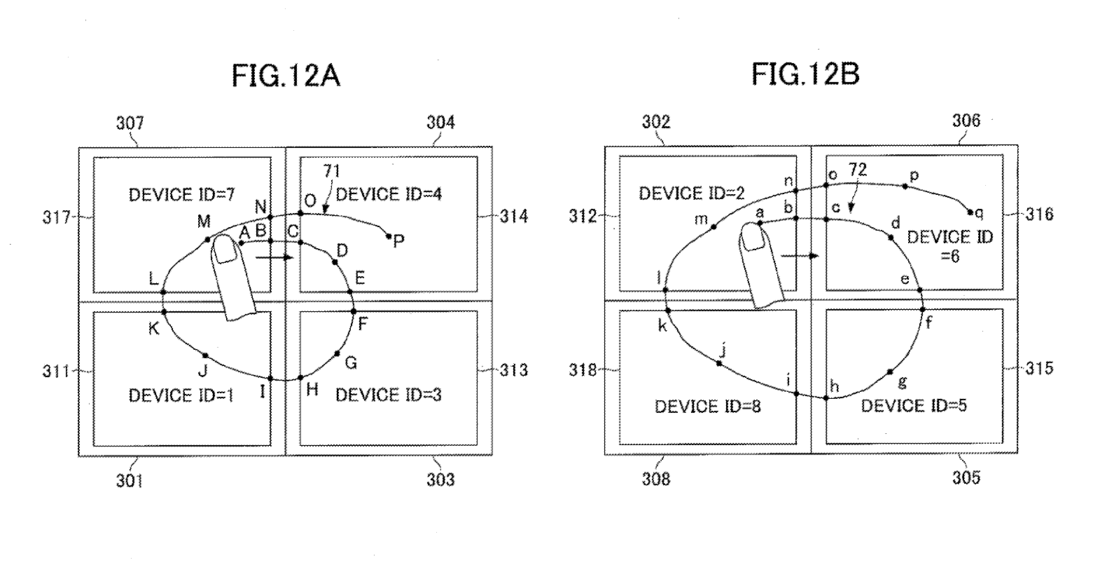

Next, with reference to FIGS. 12A through 20, a detailed description is given of the grouping process according to the present embodiment.

FIGS. 12A and 12B illustrate how coordinate information is input to the terminal devices according to the first embodiment. In FIGS. 12A and 12B, eight terminal devices 301, 302, 303, 304, 305, 306, 307, and 308 are divided and arranged in two groups, with each group including four devices. In the example of FIGS. 12A and 12B, the terminal devices 301, 303, 304, and 307 form group 1, and the terminal devices 302, 305, 306, and 308 form group 2.

In group 1, the terminal devices 301, 303, 304, and 307 are arranged such that their respective display areas 311, 313, 314, and 317 all face the same direction. That is to say, in the respective display areas 311, 313, 314, and 317, the origins of coordinate values (0, 0) are located at the top left position. In the display areas 311, 313, 314, and 317, coordinate information of handwriting 71 that crosses the boundaries of the terminal devices is input, to group the terminal devices 301, 303, 304, and 307 into group 1.

Similarly, in group 2, the terminal devices 302, 305, 306, and 308 are arranged such that their respective display areas 312, 315, 316, and 318 all face the same direction. That is to say, in the respective display areas 312, 315, 316, and 318, the origins of coordinate values (0, 0) are located at the top left position. In the display areas 312, 315, 316, and 318, coordinate information of handwriting 72 that crosses the boundaries of the terminal devices is input, to group the terminal devices 302, 305, 306, and 308 into group 2.

The device IDs of the terminal devices 301 through 308 are 1 through 8, respectively. The device IDs of the terminal devices 301 through 308 are included in the group information 251 stored in the group information database 250 of the grouping server 200.

A description is given of the handwriting 71 of FIG. 12A. The starting point of the handwriting 71 is a point A in the display area 317, and the ending point of handwriting 71 is a point P in the display area 314. The handwriting 71 is drawn by performing pen-up at a point B in the display area 317, and performing pen-down at a point C in the display area 314. Next, the handwriting 71 is drawn by passing through a point D and performing pen-up at a point E in the display area 314, and performing pen-down at a point F in the display area 313. Next, the handwriting 71 is drawn by passing through a point G and performing pen-up at a point H in the display area 313, and performing pen-down at a point I in the display area 311. Next, the handwriting 71 is drawn by passing through a point J and performing pen-up at a point K in the display area 311, and performing pen-down at a point L in the display area 317. Next, the handwriting 71 is drawn by passing through a point M and performing pen-up at a point N in the display area 317, and performing pen-down at a point O in the display area 314, and then the handwriting 71 ends at the point P.

A description is given of the handwriting 72 of FIG. 12B. The starting point of the handwriting 72 is a point a in the display area 312, and the ending point of handwriting 72 is a point q in the display area 316. The handwriting 72 starts from the point a in the display area 312, and is drawn by performing pen-up at a point b, and performing pen-down at a point c in the display area 316. Next, the handwriting 72 is drawn by passing through a point d and performing pen-up at a point e in the display area 316, and performing pen-down at a point f in the display area 315. Next, the handwriting 72 is drawn by passing through a point g and performing pen-up at a point h in the display area 315, and performing pen-down at a point i in the display area 318. Next, the handwriting 72 is drawn by passing through a point j and performing pen-up at a point k in the display area 318, and performing pen-down at a point l in the display area 312. Next, the handwriting 72 is drawn by passing through a point m and performing pen-up at a point n in the display area 312, and performing pen-down at a point o in the display area 316. Next, the handwriting 72 is drawn by passing through a point p in the display area 316, and then the handwriting 72 ends at the point q in the display area 316.

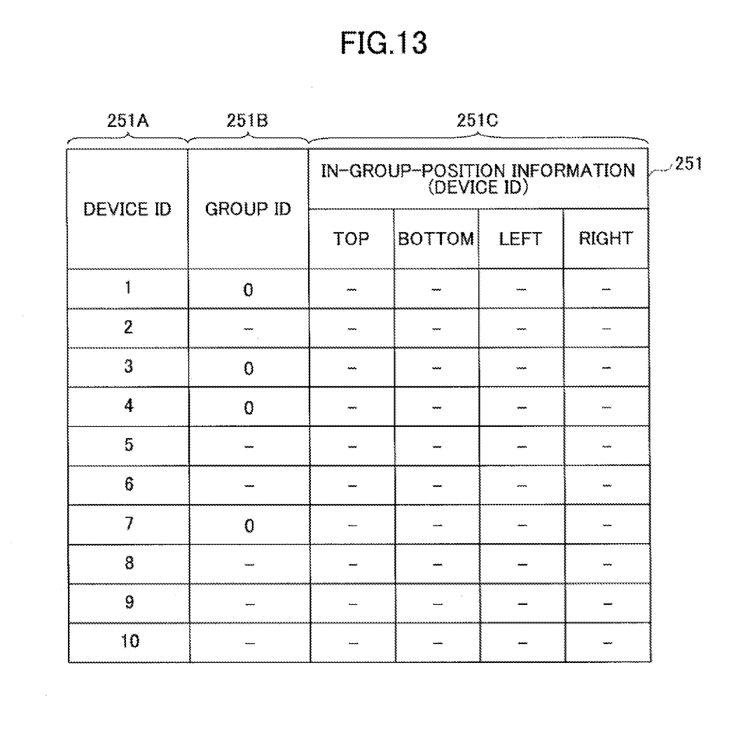

Next, a description is given of the group information 251 with reference to FIG. 13.

FIG. 13 illustrates an example of the group information 251 according to the first embodiment. FIG. 13 illustrates the group information 251 before the grouping process. The group information 251 according to the present embodiment includes device IDs 251A, group IDs 251B, and in-group-position information items 251C. The group IDs 251B are for identifying the groups after the grouping process. The in-group-position information items 251C indicate the positions of the terminal devices 301 through 308 in the group after the grouping process. Specifically, the in-group-position information items 251C indicate the terminal devices positioned on the top, the bottom, the left, and the right of the self device.

The group information 251 according to the present embodiment may include the device IDs of terminal devices other than the terminal devices 301 through 308 that are to be grouped together. In the group information 251 of FIG. 13, a terminal device having a device ID 9 and a terminal device having a device ID 10 are not targets of the grouping process. Furthermore, the group information 251 according to the present embodiment may have a list, which includes the device IDs sorted in an ascending order and associated with corresponding information, stored in the group information database 250.

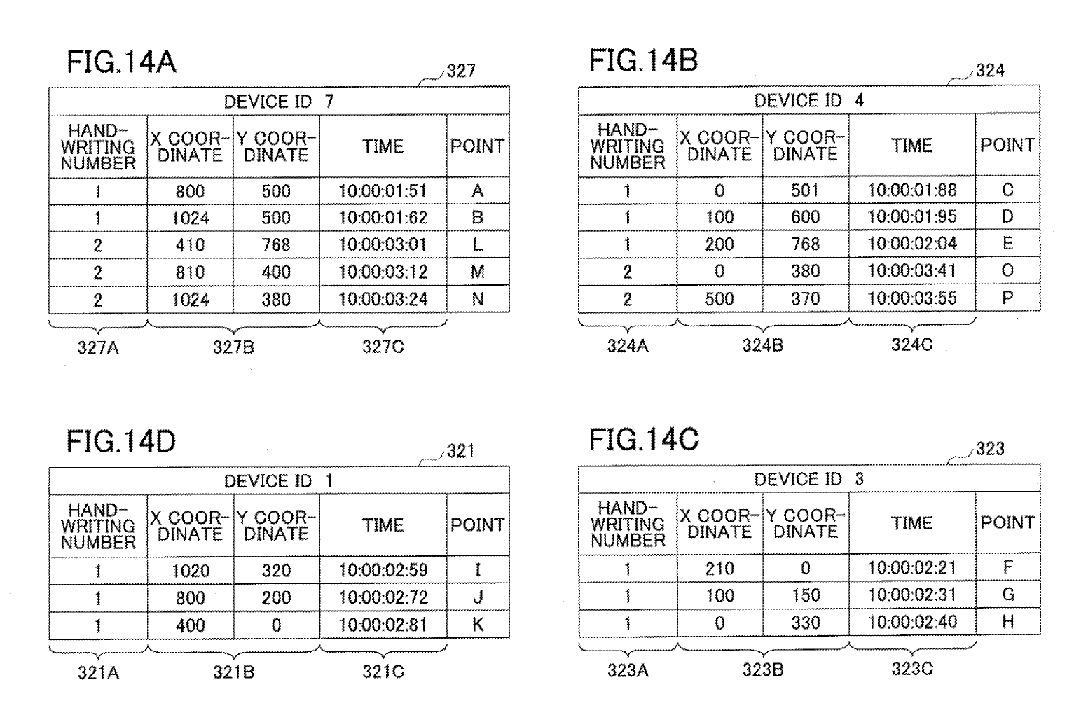

Next, a description is given of the determination-use information according to the first embodiment. FIGS. 14A through 14D are first diagrams illustrating examples of the determination-use information according to the first embodiment. FIG. 14A illustrates determination-use information 327 received from the terminal device 307 having a device ID 7. FIG. 14B illustrates determination-use information 324 received from the terminal device 304 having a device ID 4. FIG. 14C illustrates determination-use information 323 received from the terminal device 303 having a device ID 3. FIG. 14D illustrates determination-use information 321 received from the terminal device 301 having a device ID 1.

The determination-use information 327 illustrated in FIG. 14A includes the device ID of the terminal device 307, handwriting number 327A, coordinate information 327B, and time information 327C. The handwriting number 327A specifies the handwriting including the points A and B and the handwriting including the points L, M, and N input to the display area 317. The coordinate information 327B indicates coordinates of the respective points acquired in the display area 317. The time information 327C indicates the time when the coordinates of the respective points are acquired.

The determination-use information 324 illustrated in FIG. 14B includes the device ID of the terminal device 304, handwriting number 324A, coordinate information 324B, and time information 324C. The handwriting number 324A specifies the handwriting including the points C, D, and E and the handwriting including the points O and P input to the display area 314. The coordinate information 324B indicates coordinates of the respective points acquired in the display area 314. The time information 324C indicates the time when the coordinates of the respective points are acquired.

The determination-use information 323 illustrated in FIG. 14C includes the device ID of the terminal device 303, handwriting number 323A, coordinate information 323B, and time information 323C. The handwriting number 323A specifies the handwriting including the points F, G, and H input to the display area 313. The coordinate information 323B indicates coordinates of the respective points acquired in the display area 313. The time information 323C indicates the time when the coordinates of the respective points are acquired.

The determination-use information 321 illustrated in FIG. 14D includes the device ID of the terminal device 301, handwriting number 321A, coordinate information 321B, and time information 321C. The handwriting number 321A specifies the handwriting including the points I, J, and K input to the display area 311. The coordinate information 321B indicates coordinates of the respective points acquired in the display area 311. The time information 321C indicates the time when the coordinates of the respective points are acquired.

The numbers of points for which coordinate values are acquired in the display areas in the present embodiment is not limited to the numbers indicated in FIGS. 14A through 14D. In the respective display areas, coordinate values of more points may be acquired.

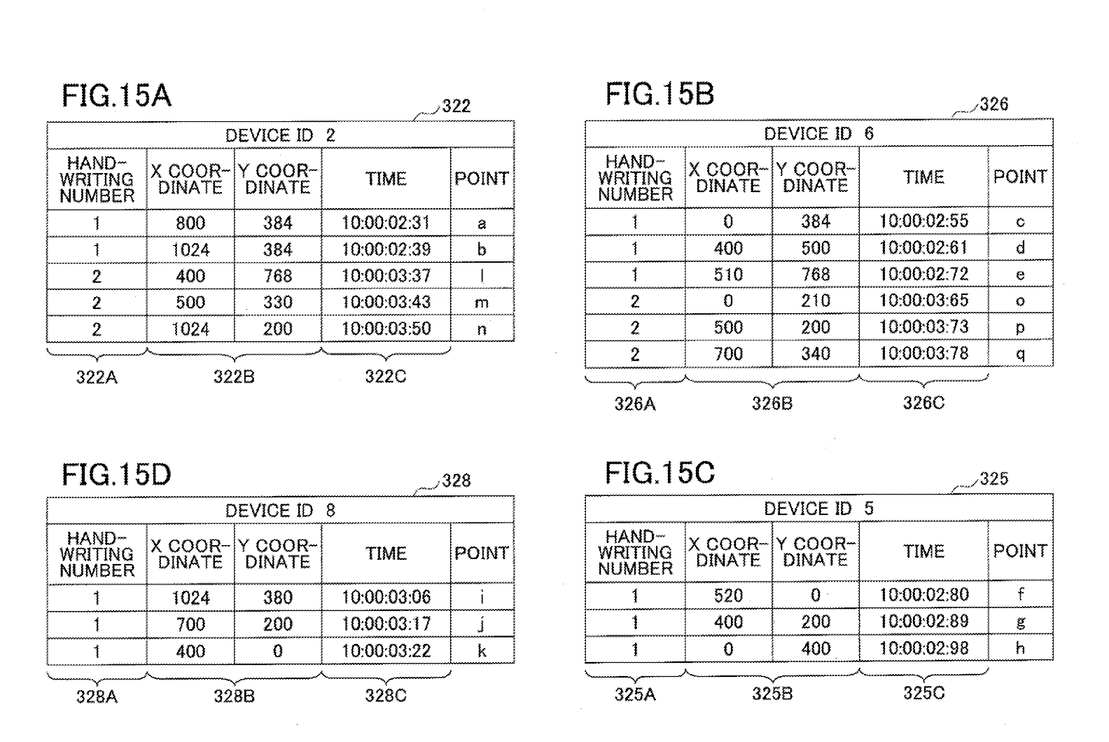

FIGS. 15A through 15D are second diagrams illustrating examples of the determination-use information according to the first embodiment. FIG. 15A illustrates determination-use information 322 received from the terminal device 302 having a device ID 2. FIG. 15B illustrates determination-use information 326 received from the terminal device 306 having a device ID 6. FIG. 15C illustrates determination-use information 325 received from the terminal device 305 having a device ID 5. FIG. 15D illustrates determination-use information 328 received from the terminal device 308 having a device ID 8.

The determination-use information 322 illustrated in FIG. 15A includes the device ID of the terminal device 302, handwriting number 322A, coordinate information 322B, and time information 322C. The handwriting number 322A specifies the handwriting including the points a and b and the handwriting including the points l, m, and n input to the display area 312. The coordinate information 322B indicates coordinates of the respective points acquired in the display area 312. The time information 322C indicates the time when the coordinates of the respective points are acquired.

The determination-use information 326 illustrated in FIG. 15B includes the device ID of the terminal device 306, handwriting number 326A, coordinate information 326B, and time information 326C. The handwriting number 326A specifies the handwriting including the points c, d, and e and the handwriting including the points o, p, and q input to the display area 316. The coordinate information 326B indicates coordinates of the respective points acquired in the display area 316. The time information 326C indicates the time when the coordinates of the respective points are acquired.

The determination-use information 325 illustrated in FIG. 15C includes the device ID of the terminal device 305, handwriting number 325A, coordinate information 325B, and time information 325C. The handwriting number 325A specifies the handwriting including the points f, g, and h input to the display area 315. The coordinate information 325B indicates coordinates of the respective points acquired in the display area 315. The time information 325C indicates the time when the coordinates of the respective points are acquired.

The determination-use information 328 illustrated in FIG. 15D includes the device ID of the terminal device 308, handwriting number 328A, coordinate information 328B, and time information 328C. The handwriting number 328A specifies the handwriting including the points i, j, and k input to the display area 318. The coordinate information 328B indicates coordinates of the respective points acquired in the display area 318. The time information 328C indicates the time when the coordinates of the respective points are acquired.

In the determination-use information illustrated in FIGS. 14A through 15D, the respective points are denoted by reference letters as a matter of convenience; however, the reference letters of the points do not need to be included in the determination-use information.

In the following, a detailed description is given of a process performed by the target coordinate point extracting unit 221 of the grouping server 200. The process performed by the target coordinate point extracting unit 221 corresponds to the process of step S1101 of FIG. 11. The target coordinate point extracting unit 221 according to the present embodiment extracts, from the each set of determination-use information, points that are at the edges of the display areas and whose differences in time information among each other are within a predetermined range, as the target coordinate points. The resolutions of the display areas 311 through 318 of the terminal devices 301 through 308 are all the same. In the present embodiment, the resolution is 768×1024. Furthermore, in the present embodiment, the range of the difference in time information is less than or equal to 0.5 seconds.

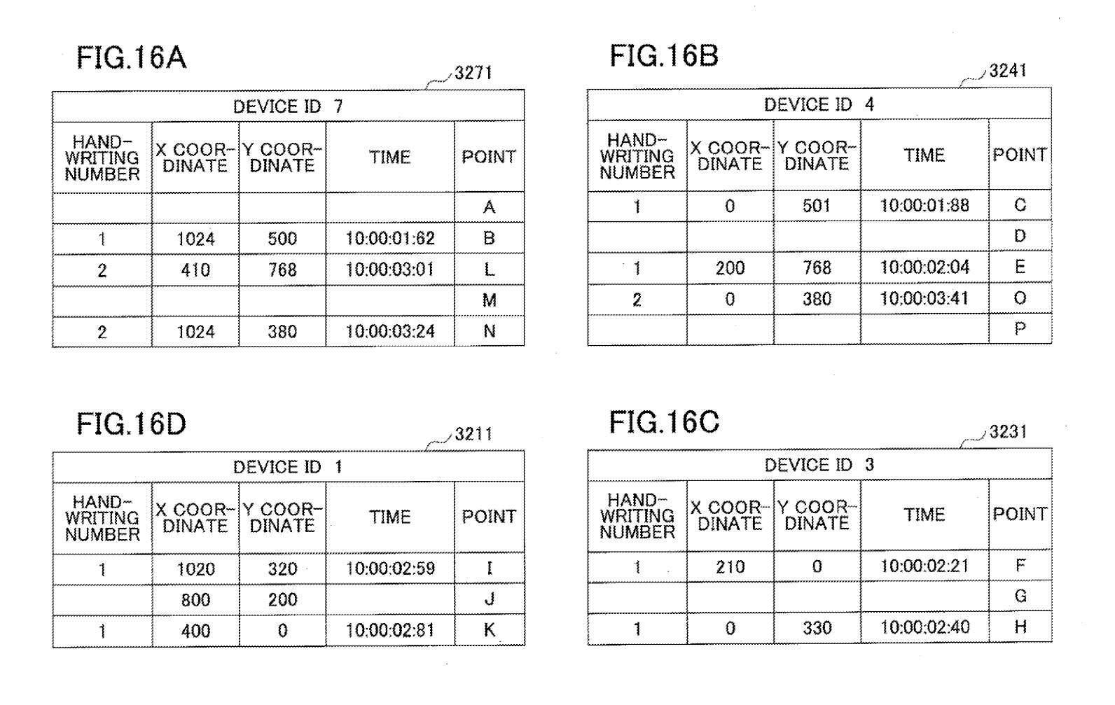

FIGS. 16A through 16D are first diagrams for describing the process performed by the target coordinate point extracting unit 221 according to the first embodiment. FIGS. 16A through 16D illustrate the operation of extracting determination-use information of edge points in the display areas of the terminal devices included in group 1.

FIG. 16A illustrates extracted determination-use information 3271 extracted from the determination-use information 327. In the determination-use information 327, it is determined from the coordinate information 327B that the points B and N having the maximum X coordinates and the point L having the maximum Y coordinate are the edge points in the display area 317. Thus, the target coordinate point extracting unit 221 extracts information relevant to the points B, L, and N from the determination-use information 327.

FIG. 16B illustrates extracted determination-use information 3241 extracted from the determination-use information 324. In the determination-use information 324, it is determined from the coordinate information 324B that the points C and O having the minimum X coordinates and the point E having the maximum Y coordinate are the edge points in the display area 314. Thus, the target coordinate point extracting unit 221 extracts information relevant to the points C, E, and O from the determination-use information 324.

FIG. 16C illustrates extracted determination-use information 3231 extracted from the determination-use information 323. In the determination-use information 323, it is determined from the coordinate information 323B that the point F having the minimum Y coordinate and the point H having the minimum X coordinate are the edge points in the display area 313. Thus, the target coordinate point extracting unit 221 extracts information relevant to the points F and H from the determination-use information 323.

FIG. 16D illustrates extracted determination-use information 3211 extracted from the determination-use information 321. In the determination-use information 321, it is determined from the coordinate information 321B that the point I having the maximum X coordinate and the point K having the minimum Y coordinate are the edge points in the display area 311. Thus, the target coordinate point extracting unit 221 extracts information relevant to the points I and K from the determination-use information 321.

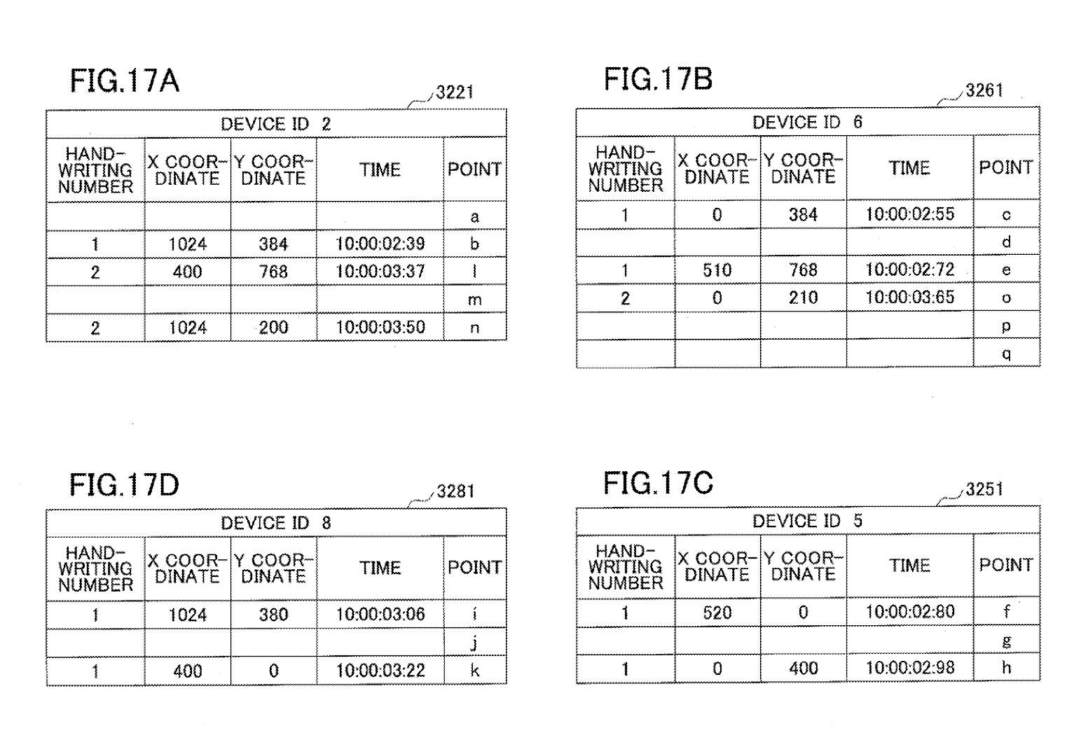

FIGS. 17A through 17D are second diagrams for describing the process performed by the target coordinate point extracting unit 221 according to the first embodiment. FIGS. 17A through 17D illustrate the operation of extracting determination-use information of edge points in the display areas of the terminal devices included in group 2.

FIG. 17A illustrates extracted determination-use information 3221 extracted from the determination-use information 322. In the determination-use information 322, similarly to FIGS. 16A through 16D, it is determined from the coordinate information 322B that the points b, 1, and n are the edge points in the display area 312. Thus, the target coordinate point extracting unit 221 extracts information relevant to the points b, 1, and n from the determination-use information 322.

FIG. 17B illustrates extracted determination-use information 3261 extracted from the determination-use information 326. In the determination-use information 326, similarly to FIGS. 16A through 16D, it is determined from the coordinate information 326B that the points c, e, and o are the edge points in the display area 316. Thus, the target coordinate point extracting unit 221 extracts information relevant to the points c, e, and o from the determination-use information 326.

FIG. 17C illustrates extracted determination-use information 3251 extracted from the determination-use information 325. In the determination-use information 325, similarly to FIGS. 16A through 16D, it is determined from the coordinate information 325B that the points f and h are the edge points in the display area 315. Thus, the target coordinate point extracting unit 221 extracts information relevant to the points f and h from the determination-use information 325.

FIG. 17D illustrates extracted determination-use information 3281 extracted from the determination-use information 328. In the determination-use information 328, similarly to FIGS. 16A through 16D, it is determined from the coordinate information 328B that the points i and k are the edge points in the display area 318. Thus, the target coordinate point extracting unit 221 extracts information relevant to the points i and k from the determination-use information 328.

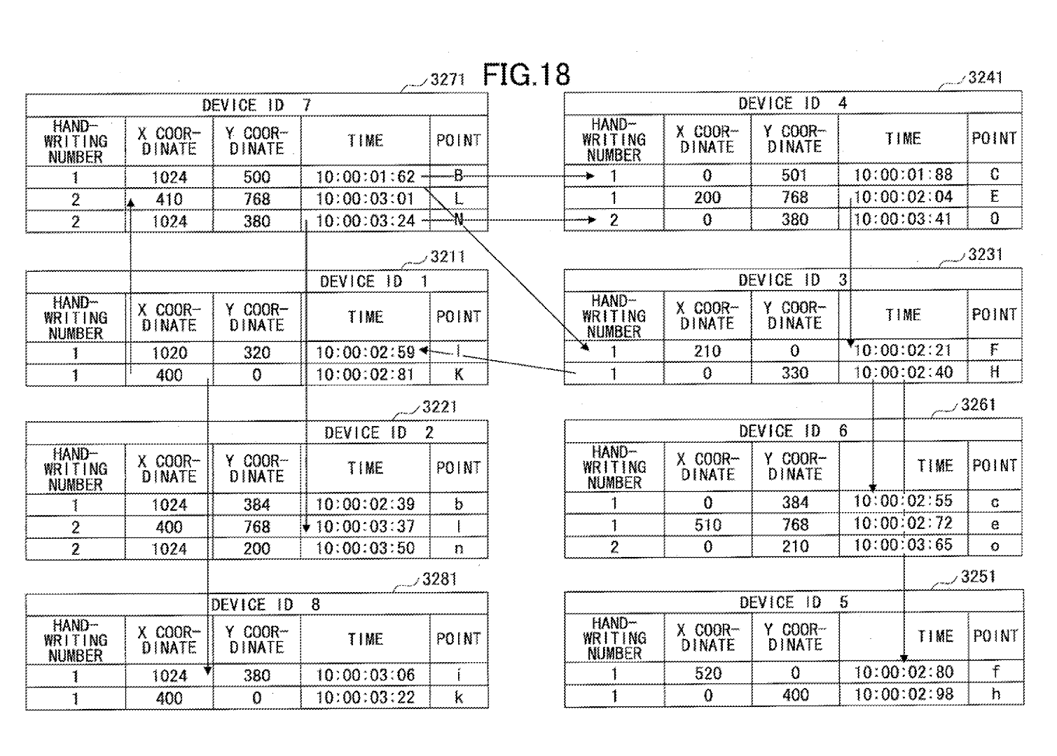

Next, with reference to FIGS. 18 ad 19, a description is given of processes performed by the target coordinate point position determining unit 222 and the coordinate point determining unit 223. The target coordinate point position determining unit 222 according to the present embodiment determines the side on which the coordinate point included in the determination-use information is located, among the top, bottom, left, and right sides of the display area. The coordinate point determining unit 223 determines the points that may form a pair included in a group, among the points included in the extracted determination-use information.

FIG. 18 is a first diagram for describing the processes of the target coordinate point position determining unit 222 and the coordinate point determining unit 223 according to the first embodiment. The target coordinate point position determining unit 222 determines the side of the display area on which each point is located, based on the X coordinates and Y coordinates included in the extracted determination-use information.

The target coordinate point position determining unit 222 according to the present embodiment determines that a point whose X coordinate is the maximum value (1024) is located on the right side of the display area, and a point whose X coordinate is the minimum value (0) is located on the left side of the display area. Furthermore, the target coordinate point position determining unit 222 determines that a point whose Y coordinate is the maximum value (768) is located on the bottom side of the display area, and a point whose Y coordinate is the minimum value (0) is located on the top side of the display area. For example, as to a point B in the extracted determination-use information 3271 indicated in FIG. 18, the X coordinate in the coordinate information is the maximum value, and therefore point B is determined to be on the right side of the display area 317. These determination results are later used for determining the logical consistency of coordinate points.

Next, the coordinate point determining unit 223 searches for a point to be paired with point B. The coordinate point determining unit 223 searches for a point for comparing the time information with point B, from extracted determination-use information other than the extracted determination-use information 3271 including point B.

When coordinate information of a point is input, it is clear whether the point is a pen-up point or a pen-down point. Furthermore, edge points that can be paired together in terminal devices to be grouped together are a pen-up point and a pen-down point. Two pen-up points cannot be paired together and two pen-down points cannot be paired together.

In the example of coordinate information according to the present embodiment, among the points having a difference in time information of 0.5 seconds or less between point B, there are only two points that may be paired with point B that is a pen-up point. Specifically, the two points are point C in extracted determination-use information 3241 and point F in extracted determination-use information 3231, which are both pen-down points.

In FIG. 18, candidate edge points that may be paired together based on the above method are indicated by arrows.

As described above, the coordinate point determining unit 223 searches the extracted determination-use information for pair candidates for which the inter-coordinate point distances are to be calculated.

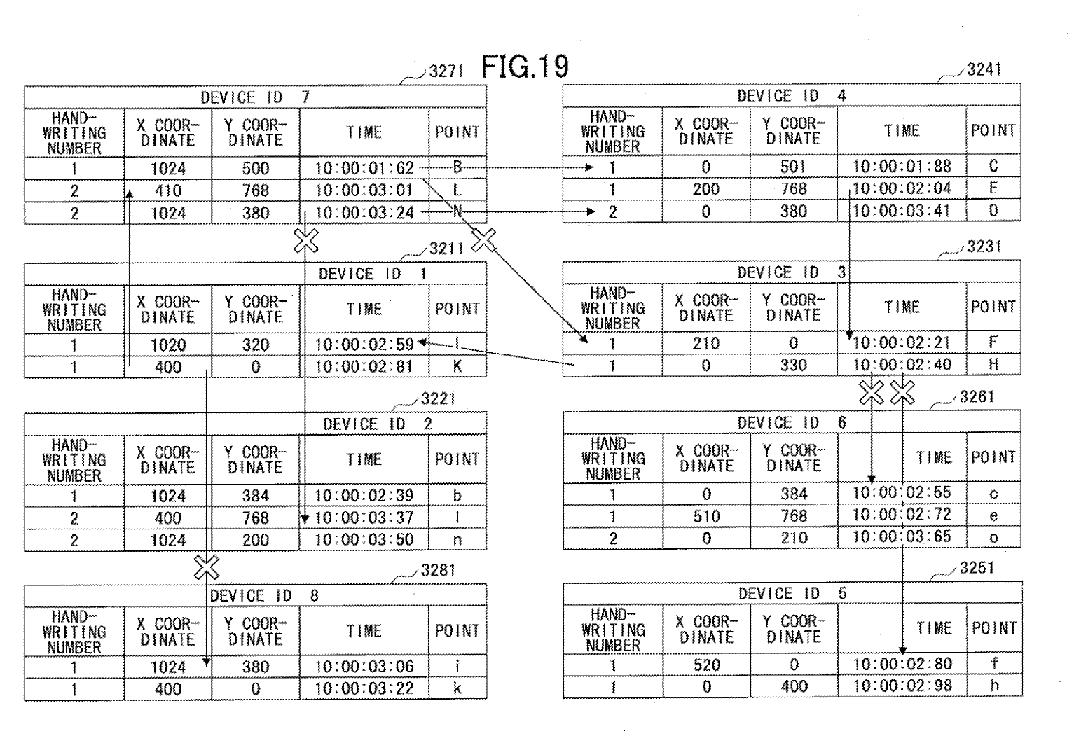

FIG. 19 is a second diagram for describing the processes of the target coordinate point position determining unit 222 and the coordinate point determining unit 223 according to the first embodiment. In FIG. 19, illustrates a state where pairs of coordinate points, for which the inter-coordinate point distances are to be calculated, have been determined by the coordinate point determining unit 223. That is to say, FIG. 19 illustrates a state where it has been determined whether there are any contradictory combinations of sides in which edge points to form pairs are located, in the pair candidates extracted in FIG. 18. Specifically, it has been determined that two pairs are contradictory, i.e., the pair including point B in the extracted determination-use information 3271 and point F in the extracted determination-use information 3231, and the pair including point N in the extracted determination-use information 3271 and point l in the extracted determination-use information 3221.

The point that can be paired with point B of the extracted determination-use information 3271 is point C of the extracted determination-use information 3241. Furthermore, the point that can be paired with point L of the extracted determination-use information 3271 is point K of the extracted determination-use information 3211. The point that can be paired with point N of the extracted determination-use information 3271 is point O of the extracted determination-use information 3241. The point that can be paired with point E of the extracted determination-use information 3241 is point F of the extracted determination-use information 3231. The point that can be paired with point H of the extracted determination-use information 3231 is point I of the extracted determination-use information 3211.

When the pairs are determined, the distance calculating unit 224 calculates the distances between the points in each of the pairs. When the distances between the points in each of the pairs are calculated, the device position determining unit 225 determines that points in a pair that are close to each other belong to the same group, and validates the positional relationships between the terminal devices 301 through 308. In the present embodiment, a threshold of the distance between two points may be set in advance, for determining whether the two points belong to the same group. Furthermore, in the present embodiment, when the calculated distance between two points is shorter than the threshold, the terminal devices, corresponding to the two sets of extracted determination-use information relevant to the two points, belong to the same group. In the present embodiment, unique pairs are determined. However, in practical situations, when there are no contradictions in the times and the positional relationships of sides, there may be plural candidate points that can be paired with a single point. In such a situation, in order to determine a unique point, the distances are calculated as described above, and the points closest to each other are determined to be a pair. Accordingly, the group of terminal devices is validated. In this case also, a threshold may be used.

In the example of FIG. 19, point B and point C are in the same group, point E and point F are in the same group, point H and point I are in the same group, point K and point L are in the same group, and point N and point O are in the same group.

Point B is located on the right side of the display area 317 of the terminal device 307, and point C is located on the left side of the display area 314 of the terminal device 304, and therefore it is determined that the terminal device 304 is located on the right of the terminal device 307. Point E is located on the bottom side of the display area 314 of the terminal device 304, and point F is located on the top side of the display area 313 of the terminal device 303, and therefore it is determined that the terminal device 303 is located under the terminal device 304.

Point H is located on the left side of the display area 313 of the terminal device 303, and point I is located on the right side of the display area 311 of the terminal device 301, and therefore it is determined that the terminal device 303 is located on the right side of the terminal device 301. Point K is located on the top side of the display area 311 of the terminal device 301, and point L is located on the bottom side of the display area 317 of the terminal device 307, and therefore it is determined that the terminal device 307 is located on top of the terminal device 301.

Therefore, the group determining unit 220 determines that the four terminal devices 307, 304, 303, and 301 belong to group 1. Furthermore, the group determining unit 220 determines that the terminal device 304 is located on the right side of the terminal device 307, the terminal device 301 is located below the terminal device 307, the terminal device 304 is located on top of the terminal device 303, and the terminal device 301 is located on the left side of the terminal device 303.

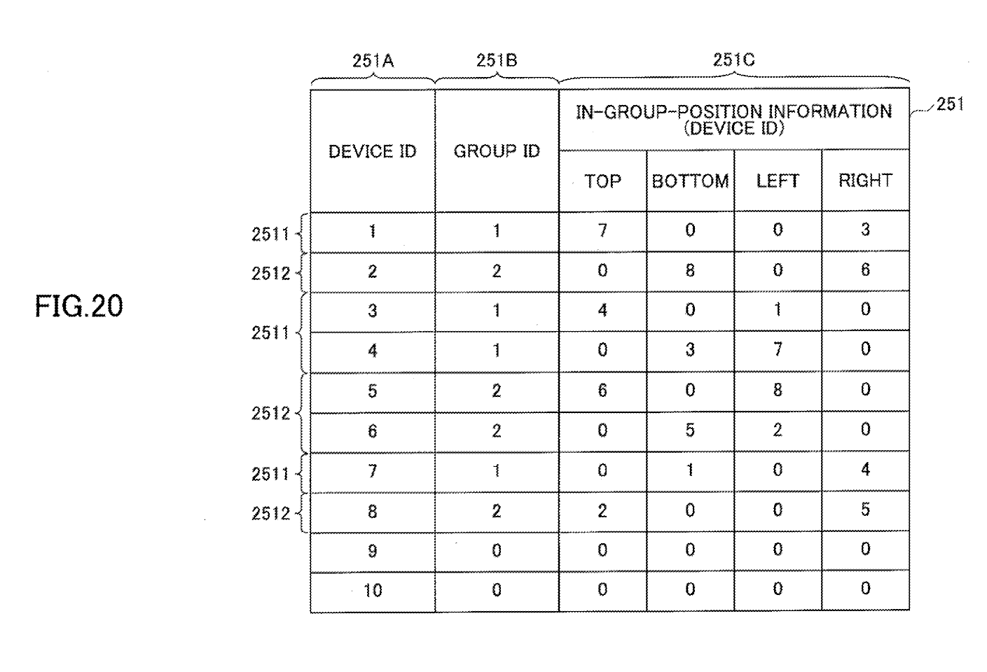

FIG. 20 illustrates an example of group information to which the group determination results are applied according to the first embodiment. As a group ID 251B in the group information 251 of FIG. 20, a value indicating the group to which the corresponding terminal device belongs is stored. For example, a group ID of 1 is stored in association with the device IDs of the terminal devices 307, 304, 303, and 301 which are determined as belonging to group 1.

Furthermore, in the in-group-position information items 251C, the device IDs of terminal devices located on the top, bottom, left side, and right side of the self device are stored. When zero is stored for a particular position, it means that there is no terminal device located at that particular position. When a terminal device corresponding to a device ID has a group ID of zero, it means that this terminal device does not belong to any group.

The in-group-position information items 251C of FIG. 20 indicates that the terminal device 307 having a device ID 7 is located above the terminal device 301 having a device ID 1, and the terminal device 303 having a device ID 3 is located on the right side of the terminal device 301. Furthermore, the terminal device 308 having a device ID 8 is located below the terminal device 302 having a device ID 2 determined as belonging to group 2, and the terminal device 306 having a device ID 6 is located on the right side of the terminal device 302.

When the group determination results are applied to the group information 251 by the group information management unit 230, the grouping server 200 extracts the group information of each group from the group information 251, and sets the extracted information as self group information. The group information 251 of FIG. 20 includes self group information 2511 having a group ID of 1 and self group information 2512 having a group ID of 2.

The grouping server 200 sends the self group information to the corresponding terminal devices, by the communications unit 210. For example, the grouping server 200 extracts the self group information 2511 from the group information 251 and sends the extracted self group information 2511 to the terminal devices 301, 303, 304, and 307 belonging to group 1.

The information sharing management unit 240 sends the self group information 2511 to the respective terminal devices 301, 303, 304, and 307 at once. When the self group information 2511 is received, the terminal devices in group 1 save the self group information 2511 in their respective group information saving units 370.

The terminal devices in group 1 display the group ID 1 in their respective display areas. When an instruction to validate the group is input at the respective terminal devices, the grouping process is completed.

As described above, in the present embodiment, the grouping server 200 forms groups by recognizing the number of terminal devices 300 and the positions of the terminal devices 300 based on coordinate information of handwriting input to plural terminal devices 300 and time information expressing when the coordinate information is input. Thus, according to the present embodiment, terminal devices can be easily grouped together.

### Second Embodiment

A description is given of a second embodiment of the present invention with reference to drawings. The second embodiment of the present invention is different from the first embodiment in terms of the arrangement of terminal devices when grouping them together. Accordingly, in the following description of the second embodiment, only the differences between the first and second embodiments are given. Elements having the same functions as those of the first embodiment are denoted by the same reference numerals and are not further described.

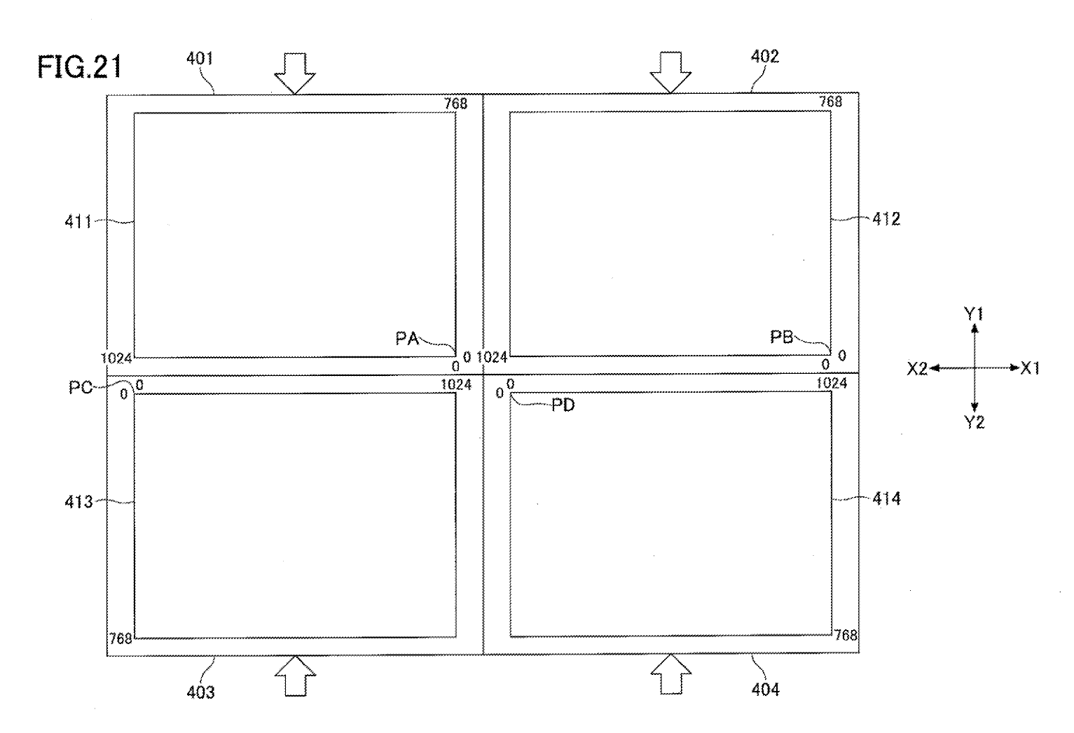

FIG. 21 illustrates an example of an arrangement of terminal devices in a grouping process according to the second embodiment. In FIG. 21, when grouping together four terminal devices 401 through 404 into one group, two terminal devices are arranged to face each other.

In an arrangement facing each other, assuming that the Y1 direction in the top direction, the Y2 direction is the bottom direction, the X1 direction is the right direction, and the X2 direction is the left direction, the origins PA and PB in the coordinate systems expressing a display area 411 of the terminal device 401 and a display area 412 of the terminal device 402 are located at the bottom right positions in the display areas 411 and 412, respectively. Furthermore, the origins PC and PD in the coordinate systems expressing a display area 413 of the terminal device 403 and a display area 414 of the terminal device 404 are located at the top left positions in the display areas 413 and 414, respectively. The terminal devices 401 through 404 have the same hardware configuration as the terminal device 300, and are examples of a terminal device 400 according to the present embodiment described below.

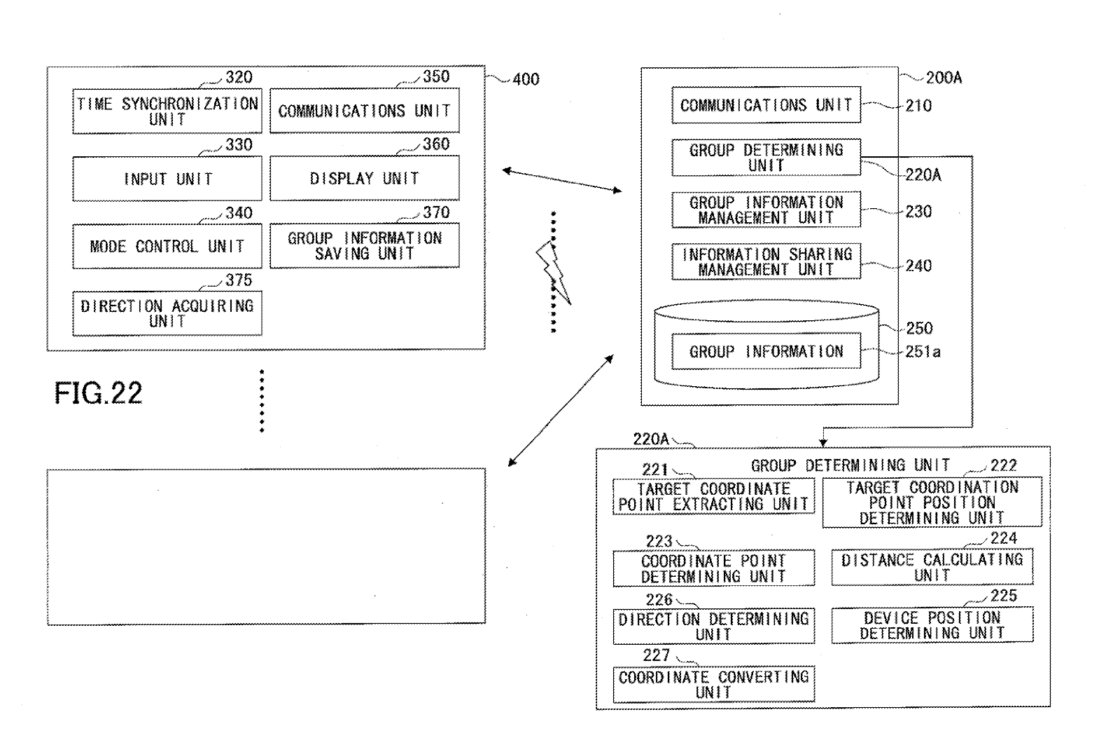

FIG. 22 illustrates functional configurations of a grouping server 200A and the terminal device 400 according to the second embodiment.

The grouping server 200A according to the present embodiment includes a group determining unit 220A. The group determining unit 220A according to the present embodiment is different from the group determining unit 220 according to the first embodiment in that the group determining unit 220A includes a direction determining unit 226 and a coordinate converting unit 227, in addition to the elements of the group determining unit 220.

The direction determining unit 226 determines the directions of the terminal devices 400 that are arranged to be grouped together, based on direction information included in the determination-use information sent from the terminal devices 400. The direction determining unit 226 according to the present embodiment determines a terminal device to be used as a reference for determining the directions of other terminal devices, and then determines the directions of the other terminal devices to be grouped together based on the direction of the reference terminal device. Specifically, the direction determining unit 226 of the present embodiment determines the directions of the other terminal devices by using, as a reference, the terminal device at the top of the list in the group information 251.

The coordinate converting unit 227 converts the coordinate values of the determination-use information based on the direction determined by the direction determining unit 226.

The terminal device 400 has the same hardware configuration as the terminal device 300. The terminal device 400 includes a direction acquiring unit 375 in addition to the elements included in the terminal device 300 according to the first embodiment. The direction acquiring unit 375 acquires direction information indicating the direction of the self device.

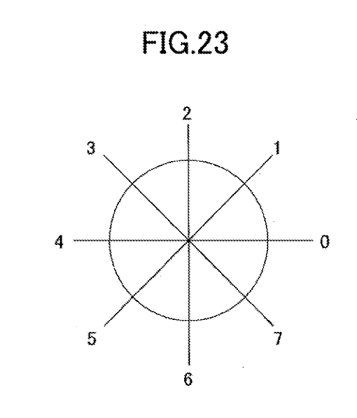

With reference to FIG. 23, a description is given of the direction acquiring unit 375 according to the present embodiment. FIG. 23 is for describing directions in the second embodiment.

The direction acquiring unit 375 according to the present embodiment is implemented by, for example, a direction sensor. The direction acquiring unit 375 sets angles obtained by dividing 360 degrees by eight as directions 0 through 7, and acquires direction information indicating the directions.

In the terminal device according to the present embodiment, the position of the origin in the coordinate system expressing the display area may be associated with a direction. For example, as in the terminal device 403, the direction information of the terminal device 403 may be 2 when the origin PC in the display area 413 is positioned at the top left of the display area 413. For example, as in the terminal device 401, the direction information of the terminal device 401 may be 6 when the origin PA in the display area 411 is positioned at the bottom right of the display area 411. Similarly, in the other terminal devices of the present embodiment, the position of the origin may be associated with the direction.

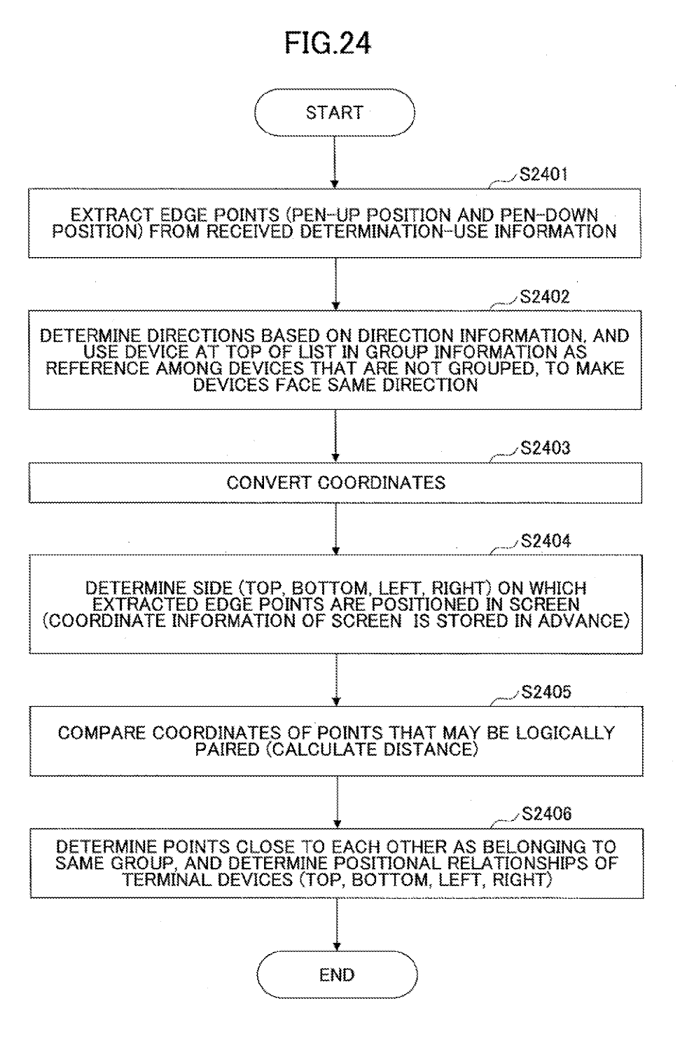

FIG. 24 is a flowchart of a process performed by the group determining unit 220A according to the second embodiment.

Step S2401 in FIG. 24 is the same as step S1101 of FIG. 11 and is thus not further described.

Next, the direction determining unit 226 determines the directions of the terminal devices 401 through 404 based on direction information included in the determination-use information (step S2402). For example, the direction determining unit 226 according to the present embodiment uses the terminal device at the top of the list in the group information 251 as a reference, to determine the directions of the other terminal devices. Furthermore, when there is a terminal device that is not in the direction directly opposite to that of the reference terminal device, such a terminal device is likely to belong to another group, and therefore the direction determining unit 226 excludes such a terminal device from the grouping targets.

Next, the coordinate converting unit 227 performs conversion on the coordinate values of the terminal devices in accordance with the terminal device set as the reference in determining the directions (step S2403). Details of the process of the direction determining unit 226 and the coordinate converting unit 227 are given below.

The processes of steps S2404 through S2406 are the same as the processes of steps S1102 through S1104 of FIG. 11, and are thus not further described.

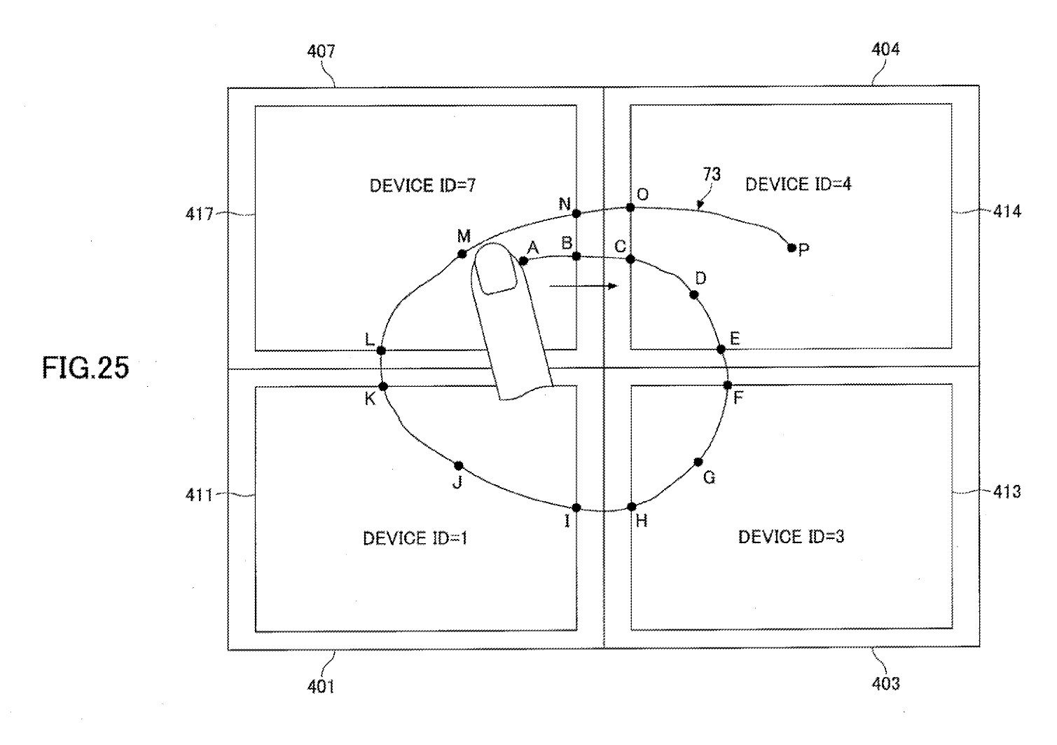

In the following, with reference to FIGS. 25 through 29, a detailed description is given of the grouping process according to the present embodiment.

FIG. 25 illustrates how coordinate information is input to terminal devices according to the second embodiment.

In FIG. 25, four terminal devices 401, 403, 404, and 407 are arranged as group 1. In group 1, the terminal devices 401, 403, 404, and 407 are arranged such that the terminal device 407 faces the terminal device 401 and the terminal device 404 faces the terminal device 403. Specifically, the terminal devices 401 and 407 are arranged such that the side of a display area 411 of the terminal device 401 having a Y coordinate of “0” is adjacent to the side of a display area 417 of the terminal device 407 having a Y coordinate of “0”. Furthermore, the terminal devices 403 and 404 are arranged such that the side of a display area 413 of the terminal device 403 having a Y coordinate of “0” is adjacent to the side of a display area 414 of the terminal device 404 having a Y coordinate of “0”.

Coordinate information of handwriting 73 is input to the display areas 411, 413, 414, and 417. The handwriting 73 crosses the boundaries of the terminal devices 401, 403, 404, and 407 to group these terminal devices into group 1.

Next, a description is given of determination-use information according to the second embodiment.

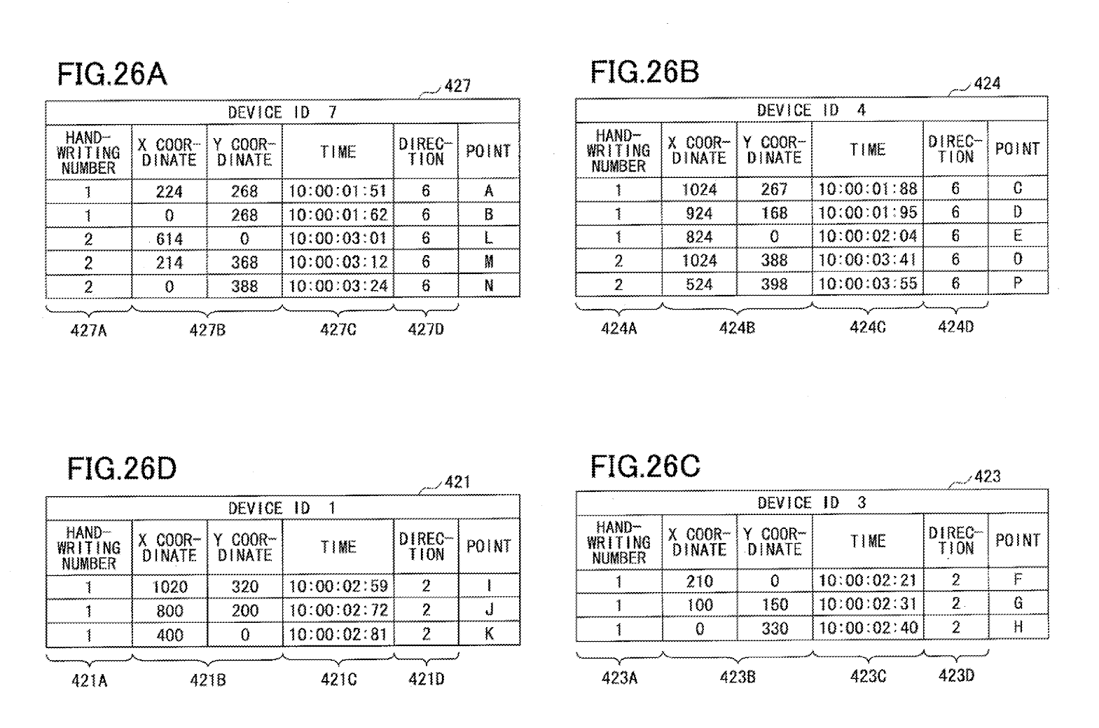

FIG. 26A illustrates determination-use information 427 received from the terminal device 407 having a device ID 7, and FIG. 26B illustrates determination-use information 424 received from the terminal device 404 having a device ID 4. FIG. 26C illustrates determination-use information 423 received from the terminal device 403 having a device ID 3, and FIG. 26D illustrates determination-use information 421 received from the terminal device 401 having a device ID 1.

The determination-use information 427 illustrated in FIG. 26A includes the device ID of the terminal device 407, handwriting number 427A, coordinate information 427B, time information 427C, and direction information 427D. The handwriting number 427A specifies the handwriting including the points A and B and the handwriting including the points L, M, and N input to the display area 417. The coordinate information 427B indicates coordinates of the respective points acquired in the display area 417. The time information 427C indicates the time when the coordinates of the respective points are acquired. The direction information 427D indicates the direction of the terminal device 407.

The determination-use information 424 illustrated in FIG. 26B includes the device ID of the terminal device 404, handwriting number 424A, coordinate information 424B, time information 424C, and direction information 424D. The handwriting number 424A specifies the handwriting including the points C, D, and E and the handwriting including the points 0 and P input to the display area 414. The coordinate information 424B indicates coordinates of the respective points acquired in the display area 414. The time information 424C indicates the time when the coordinates of the respective points are acquired. The direction information 424D indicates the direction of the terminal device 404.

The determination-use information 423 illustrated in FIG. 26C includes the device ID of the terminal device 403, handwriting number 423A, coordinate information 423B, time information 423C, and direction information 423D. The handwriting number 423A specifies the handwriting including the points F, G, and H input to the display area 413. The coordinate information 423B indicates coordinates of the respective points acquired in the display area 413. The time information 423C indicates the time when the coordinates of the respective points are acquired. The direction information 423D indicates the direction of the terminal device 403.

The determination-use information 421 illustrated in FIG. 26D includes the device ID of the terminal device 401, handwriting number 421A, coordinate information 421B, time information 421C, and direction information 421D. The handwriting number 421A specifies the handwriting including the points I, J, and K input to the display area 411. The coordinate information 421B indicates coordinates of the respective points acquired in the display area 411. The time information 421C indicates the time when the coordinates of the respective points are acquired. The direction information 421D indicates the direction of the terminal device 401.

In the following, a detailed description is given of a process performed by the target coordinate point extracting unit 221 of the grouping server 200A according to the present embodiment. The process performed by the target coordinate point extracting unit 221 corresponds to the process of step S2401 of FIG. 24.

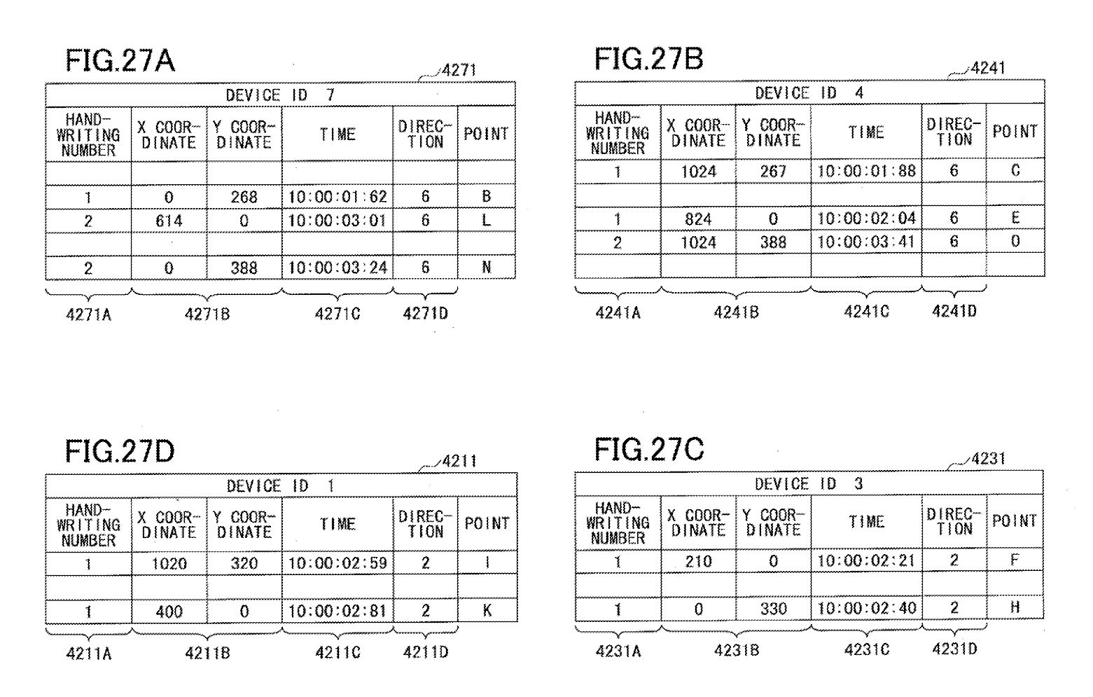

FIGS. 27A through 27D are diagrams for describing the process performed by the target coordinate point extracting unit 221 according to the second embodiment. FIGS. 27A through 27D illustrate the operation of extracting determination-use information of edge points in the display areas of the terminal devices included in group 1.

FIG. 27A illustrates extracted determination-use information 4271 extracted from the determination-use information 427. In the determination-use information 427, it is determined from the coordinate information 427B that the points B and N having the minimum X coordinates and the point L having the minimum Y coordinate are the edge points in the display area 417. Thus, the target coordinate point extracting unit 221 extracts information relevant to the points B, L, and N from the determination-use information 427.

FIG. 27B illustrates extracted determination-use information 4241 extracted from the determination-use information 424. In the determination-use information 424, it is determined from the coordinate information 424B that the points C and O having the maximum X coordinates and the point E having the minimum Y coordinate are the edge points in the display area 414. Thus, the target coordinate point extracting unit 221 extracts information relevant to the points C, E, and O from the determination-use information 424.

FIG. 27C illustrates extracted determination-use information 4231 extracted from the determination-use information 423. In the determination-use information 423, it is determined from the coordinate information 423B that the point F having the minimum Y coordinate and the point H having the minimum X coordinate are the edge points in the display area 413. Thus, the target coordinate point extracting unit 221 extracts information relevant to the points F and H from the determination-use information 423.

FIG. 27D illustrates extracted determination-use information 4211 extracted from the determination-use information 421. In the determination-use information 421, it is determined from the coordinate information 421B that the point I having the maximum X coordinate and the point K having the minimum Y coordinate are the edge points in the display area 411. Thus, the target coordinate point extracting unit 221 extracts information relevant to the points I and K from the determination-use information 421.

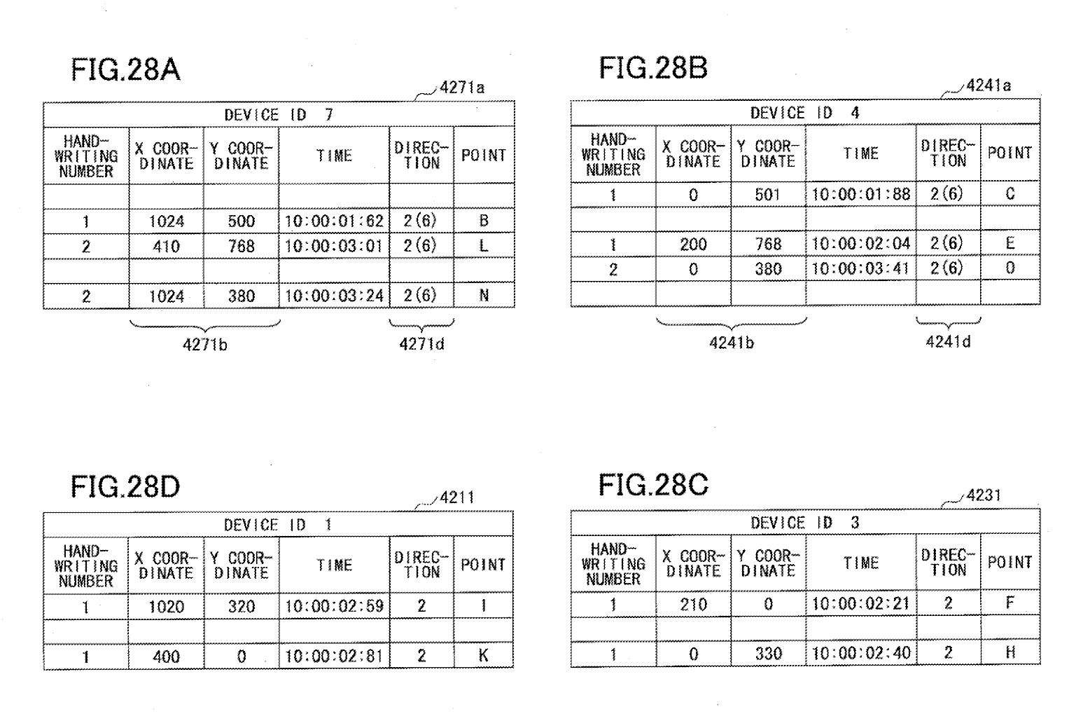

Next, a detailed description is given of the processes of the direction determining unit 226 and the coordinate converting unit 227 according to the present embodiment. FIGS. 28A through 28D are for describing the process of the direction determining unit 226 and the coordinate converting unit 227 according to the second embodiment.

FIG. 28A indicates post-conversion determination-use information 4271a obtained by determining the direction of the terminal device 407 from the direction information 427D of the extracted determination-use information 4271, and performing coordinate conversion.

FIG. 28B indicates post-conversion determination-use information 4241a obtained by determining the direction of the terminal device 404 from the direction information 424D of the extracted determination-use information 4241, and performing coordinate conversion.

FIGS. 28C and 28D illustrate the extracted determination-use information 4231 and the extracted determination-use information 4211 illustrated in FIGS. 27C and 27D, respectively.

In the present embodiment, the direction determining unit 226 uses the terminal device at the top of the list in the group information 251 as a reference to determine the directions of the other terminal devices. In the group information 251 according to the present embodiment, the device IDs are listed in ascending order, as illustrated in FIG. 20. That is to say, in the group information 251, the terminal device 401 having the device ID 1 is the terminal device at the top of the list. Accordingly, the direction determining unit 226 uses the direction of the terminal device 401 to determine the directions of the other terminal devices 403, 404, and 407.

The direction of the terminal device 401 is direction 2, according to direction information 4211D of the extracted determination-use information 4211. Furthermore, according to direction information 4271D of the extracted determination-use information 4271, the direction of the terminal device 407 is direction 6. Based on these two direction information items, the direction determining unit 226 determines that the direction of the terminal device 407 is opposite to that of the terminal device 401, and requests the coordinate converting unit 227 to convert coordinate information 4271B so that the direction of the terminal device 407 becomes the same as the direction of the terminal device 401.

The direction determining unit 226 may turn the direction information 4271D into direction information 4271d, in which the direction 6 of the terminal device 407 and the direction 2 that is the reference for coordinate conversion are associated with each other.

The coordinate converting unit 227 converts the values of the coordinate information 4271B into values such that the direction of the terminal device 407 is the same as the direction of the terminal device 401. Specifically, the coordinate converting unit 227 subtracts the value of the X coordinate of the coordinate information 4271B from the maximum X coordinate, and sets the value obtained as a result of the subtraction as the X coordinate value of the coordinate information 4271b after conversion. Furthermore, the coordinate converting unit 227 subtracts the value of the Y coordinate of the coordinate information 4271B from the maximum Y coordinate, and sets the value obtained as a result of the subtraction as the Y coordinate value of the coordinate information 4271b after conversion.

The post-conversion determination-use information 4241a indicated in FIG. 28B is also subjected to coordinate conversion in the same manner as the post-conversion determination-use information 4271a, so that coordinate information 4241b and direction information 4241d are included.

By performing coordinate conversion in the above manner, the coordinate information input to the terminal devices are converted such that all terminal devices are facing the same direction. Accordingly, group determination can be performed by the same process as the case where all terminal devices are facing the same direction. Thus, the group determining unit 220A according to the present embodiment performs the same process as steps S1102 through S1104 of FIG. 11 from step S2404 and subsequent steps.

In the following, an example of group information 251a is indicated, to which the group determination results are applied by the group information management unit 230.

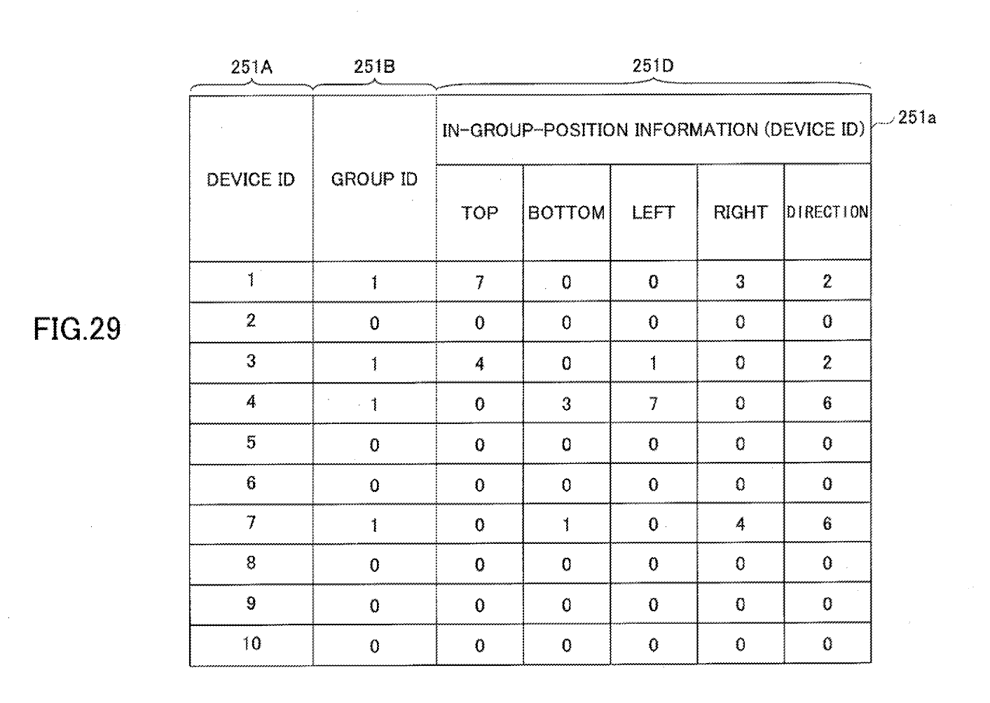

FIG. 29 indicates an example of the group information 251a to which group determination results are applied according to the second embodiment. In-group-position information items 251D indicated in FIG. 29 include direction information indicating the directions of the terminal devices.

As described above, in the present embodiment, even when the terminal devices are arranged facing each other, group determination can be easily performed.

### Third Embodiment

A description is given of a third embodiment of the present invention with reference to drawings. The third embodiment of the present invention is different from the first embodiment in terms of the sizes of terminal devices when grouping them together. Accordingly, in the following description of the third embodiment, only the differences between the first and third embodiments are given. Elements having the same functions as those of the first embodiment are denoted by the same reference numerals and are not further described.

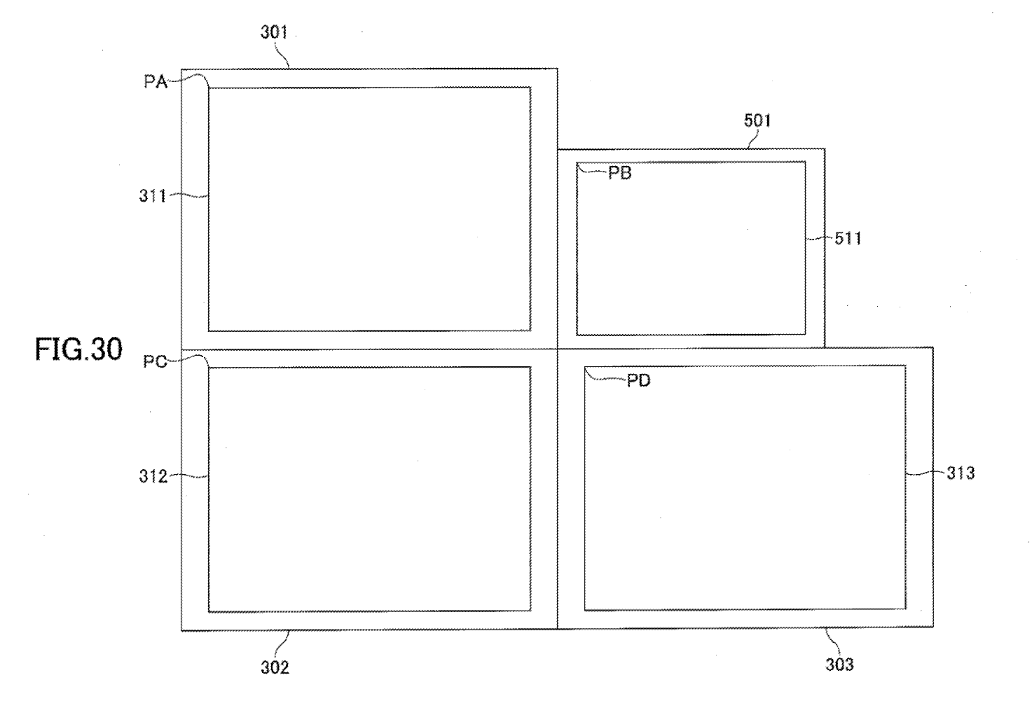

FIG. 30 illustrates an example of an arrangement of terminal devices in a grouping process according to the third embodiment.

FIG. 30 illustrates an arrangement of three terminal devices 301 through 303 and a terminal device 501 having a display area of a different size to those of the terminal devices 301 through 303, which are to be grouped together. In the example of FIG. 30, the four terminal devices are all facing the same direction. The terminal device 501 has the same hardware configuration as the terminal devices 300, and is an example of the terminal devices 300.

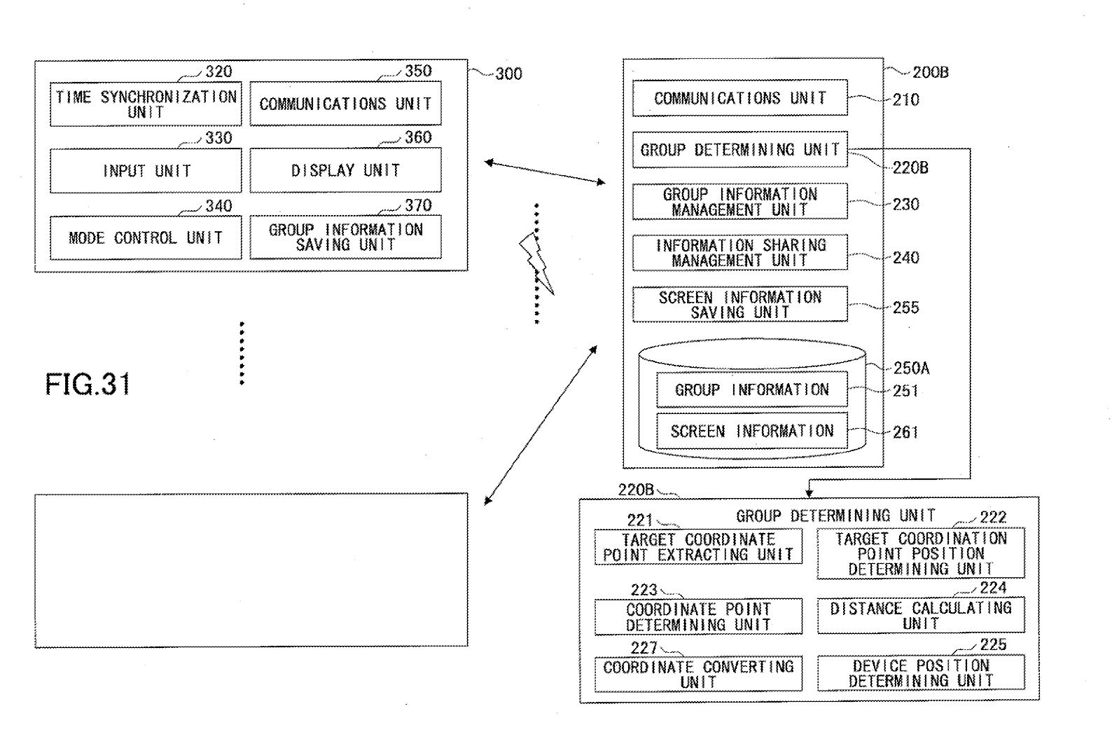

FIG. 31 illustrates functional configurations of a grouping server 200B and the terminal device 300 according to the third embodiment.

The grouping server 200B includes a group determining unit 220B and a screen information saving unit 255. The group determining unit 220B according to the present embodiment includes the target coordinate point extracting unit 221, the target coordinate point position determining unit 222, the coordinate point determining unit 223, the distance calculating unit 224, the device position determining unit 225, and the coordinate converting unit 227.

For example, when the communications unit 210 performs communications with the terminal devices, the device position determining unit 225 may acquire screen information from the terminal devices and store the information in a group information database 250A. The group information database 250A according to the present embodiment stores the group information 251 and screen information 261.

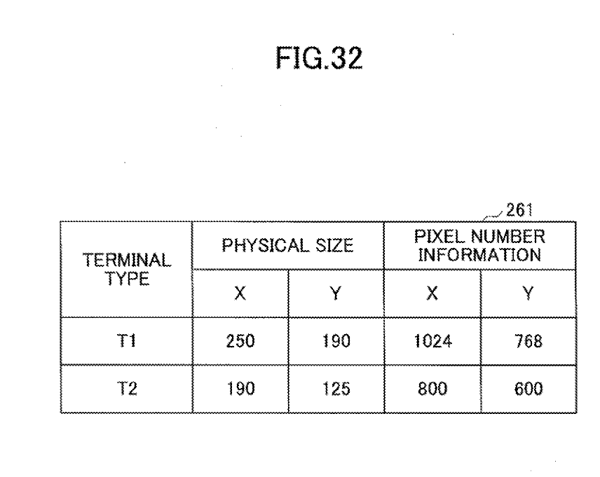

FIG. 32 illustrates an example of screen information 261 according to the third embodiment. The screen information 261 includes the types of terminal devices, the physical sizes of the display areas, and the pixel number information. For example, the type of terminal device is information indicating the machine type of the terminal device. The physical size of the display area is information indicating the size of the display area. The pixel number information is information indicating the resolution of the display area.

The grouping server 200B according to the present embodiment performs the grouping process by referring to the screen information 261.

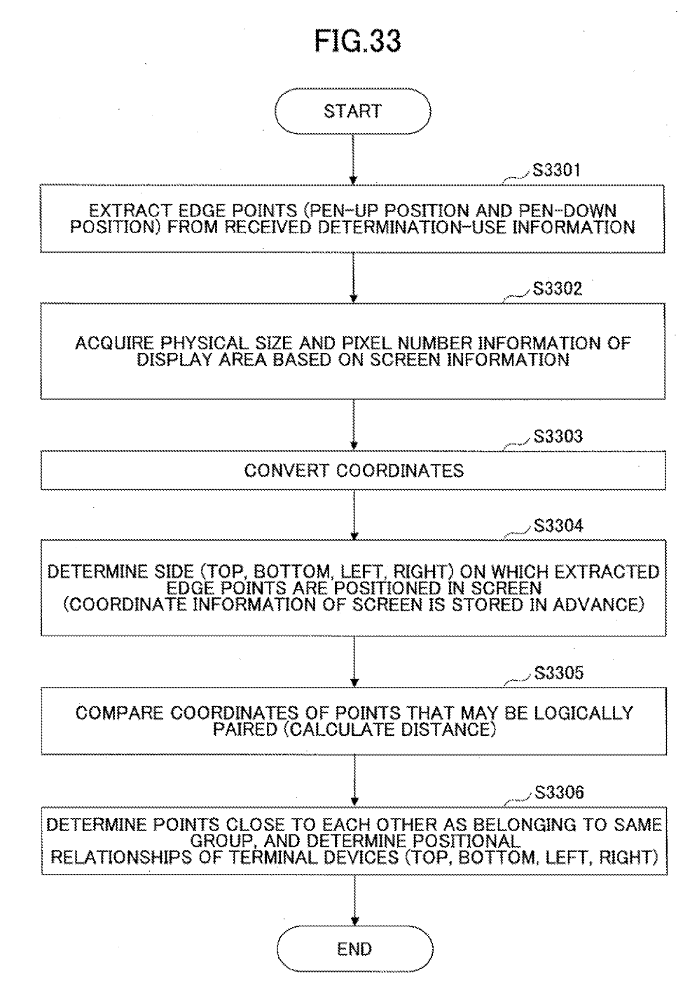

FIG. 33 is a flowchart of a process performed by the group determining unit 220B according to the third embodiment.

The process of step S3301 of FIG. 33 is the same as the process of step S1101 of FIG. 11 and is thus not further described.

Next, the group determining unit 220B acquires the screen information 261 from the group information database 250A, and acquires the physical sizes and the pixel number information of the display areas of the terminal devices (step S3302).

Next, the coordinate converting unit 227 performs conversion on the coordinate values of the terminal devices in accordance with the sizes of the display areas of the terminal devices (step S3303). Details of the process of the coordinate converting unit 227 are described below.

The processes of steps S3304 through S3306 are the same as the processes of steps S1102 through S1104 of FIG. 11, and are thus not further described.

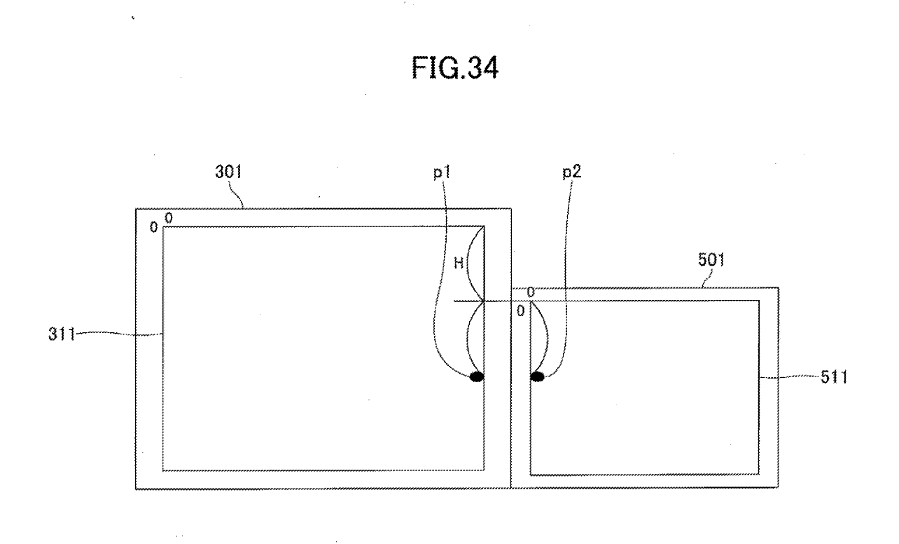

In the following, with reference to FIG. 34, a description is given of coordinate conversion according to the present embodiment. FIG. 34 is for describing coordinate conversion according to the third embodiment.

FIG. 34 illustrates an example of performing coordinate conversion such that coordinate information of point p1 in the display area 311 of the terminal device 301 and coordinate information of point p2 in the display area 511 of the terminal device 501 can be compared with each other. In the example of FIG. 34, for example, a difference H between point p1 and point p2 is subtracted from the Y coordinate of point p1. Furthermore, when point p1 and point p2 are on the top side or the bottom side of the display areas of the respective terminal devices, the same subtraction is to be performed also for the X coordinate.

Furthermore, in the present embodiment, coordinate conversion may be performed by a method other than the above-described method, so that terminal devices having display areas of different sizes can be grouped together. For example, coordinate conversion may be performed with the use of ratios of the maximum X coordinate and the maximum Y coordinate of the display area 311 of the terminal device 301, and the maximum X coordinate and the maximum Y coordinate of the display area 511 of the terminal device 501.

As described above, according to the present embodiment, terminal devices having display areas of different sizes can be easily grouped together.

### Fourth Embodiment

A description is given of a fourth embodiment of the present invention with reference to drawings. In the fourth embodiment of the present invention, the operation of displaying the input handwriting is controlled. In the following description of the fourth embodiment, only the differences between the first and third embodiments are given. Elements having the same functions as those of the first embodiment are denoted by the same reference numerals and are not further described.

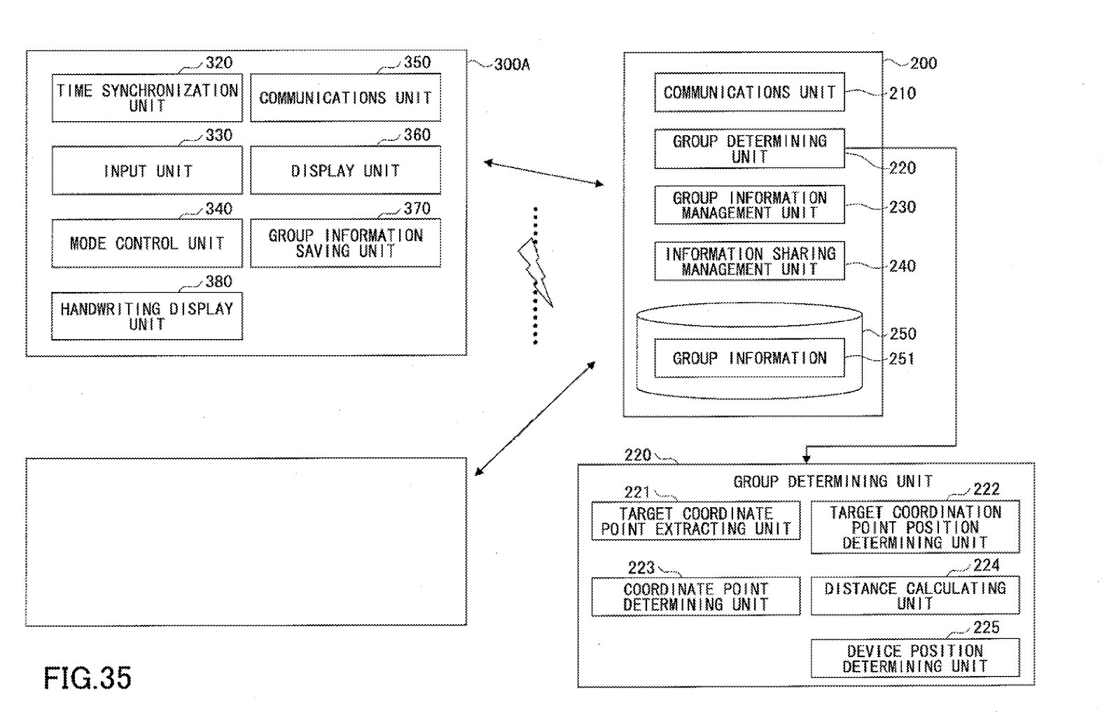

FIG. 35 illustrates functional configurations of the grouping server 200 and a terminal device 300A according to the fourth embodiment.

The terminal device 300A according to the present embodiment includes a handwriting display unit 380, in addition to the elements of the terminal device 300 according to the first embodiment. The handwriting display unit 380 according to the present embodiment causes the handwriting drawn in the display area to be displayed in the display area until the grouping process is completed.

Specifically, the handwriting display unit 380 displays, for example, the handwriting 71 illustrated in FIG. 12 and the handwriting 73 illustrated in FIG. 25 until the grouping process performed by the grouping server 200 is completed. When a group ID is reported from the grouping server 200, the handwriting display unit 380 ends the display of the handwriting.

As described above, if the handwriting is displayed until the grouping process is completed, the user can easily determine whether the desired grouping process has been performed.

### Modification

A description is given of a modification of the above-described embodiments. A first embodiment involves estimating the boundaries of terminal devices from the drawing speed of the handwriting, to improve the precision in the grouping process.

When the width of the outer frame surrounding the display area of the terminal device is known, the grouping server 200 can calculate the drawing speed based on the coordinates of the edge points in the display areas and the width of the outer frame.

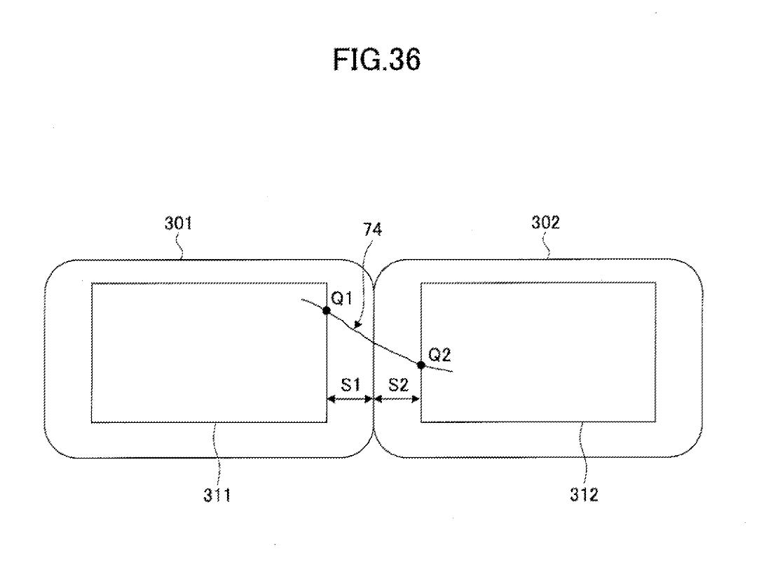

FIG. 36 is for describing the operation of estimating the boundary of terminal devices. For example, in the present modification, the grouping server 200 stores a value of a width S1 of the outer frame surrounding the display area 311 of the terminal device 301 and a value of a width S2 of the outer frame surrounding the display area 312 of the terminal device 302. Accordingly, the grouping server 200 calculates the drawing speed of handwriting 74 at the time point of drawing an edge point Q1, based on the coordinate information of the point immediately before the edge point Q1 and the time information. Based on the calculated drawing speed and the values of widths S1 and S2 of the outer frames, the time of approaching edge point Q2 can be estimated. Accordingly, it is possible to correct the time when a candidate point to be paired with the edge point Q1 is assumed to be input. Therefore, the time condition of less than or equal to 0.5 seconds between edge points to be paired together, which is set in advance in the above embodiments, can be adjusted in accordance with the drawing speed. Accordingly, the precision in group determination is improved.

Furthermore, in order to improve the precision of group determination, the handwriting preferably crosses the boundaries between terminal devices frequently. In another example using the drawing speed, the drawing speed at the edge point Q2 is calculated similarly to the drawing speed at the edge point Q1. Thus, the factor of speed is used in addition to the positions of the edge points in calculating the distance between points for determining pairs. Accordingly, the precision in group determination is improved.

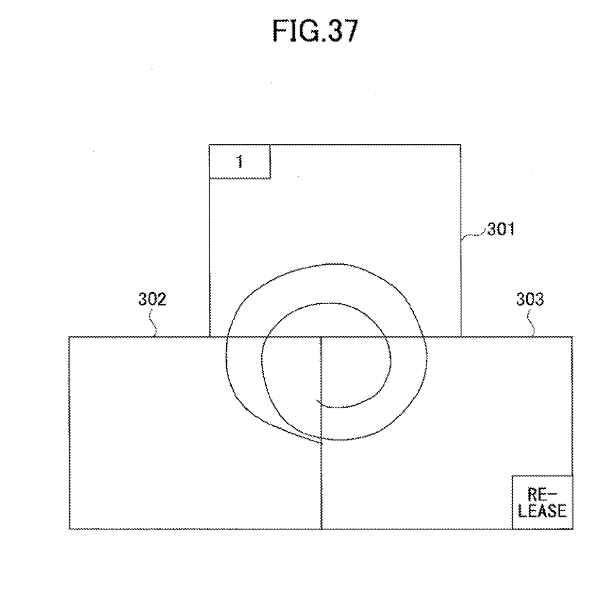

In the following, a description is given of examples of other arrangements of the terminal devices. FIG. 37 is a first diagram of an example of other arrangements of the terminal devices. In the example of FIG. 37, the terminal device 301 is shifted from the terminal devices 302 and 303. A shifted arrangement means, for example, that the right side or the left side of the display area 311 of the terminal device 301, and the right side or the left side of the display area of another terminal device are not aligned along a linear line.

In the example of FIG. 37, when it is not known how much the terminal device 301 is shifted from the terminal devices 302 and 303, it is possible to perform group determination with the use of the drawing speed of handwriting when crossing the terminal devices.

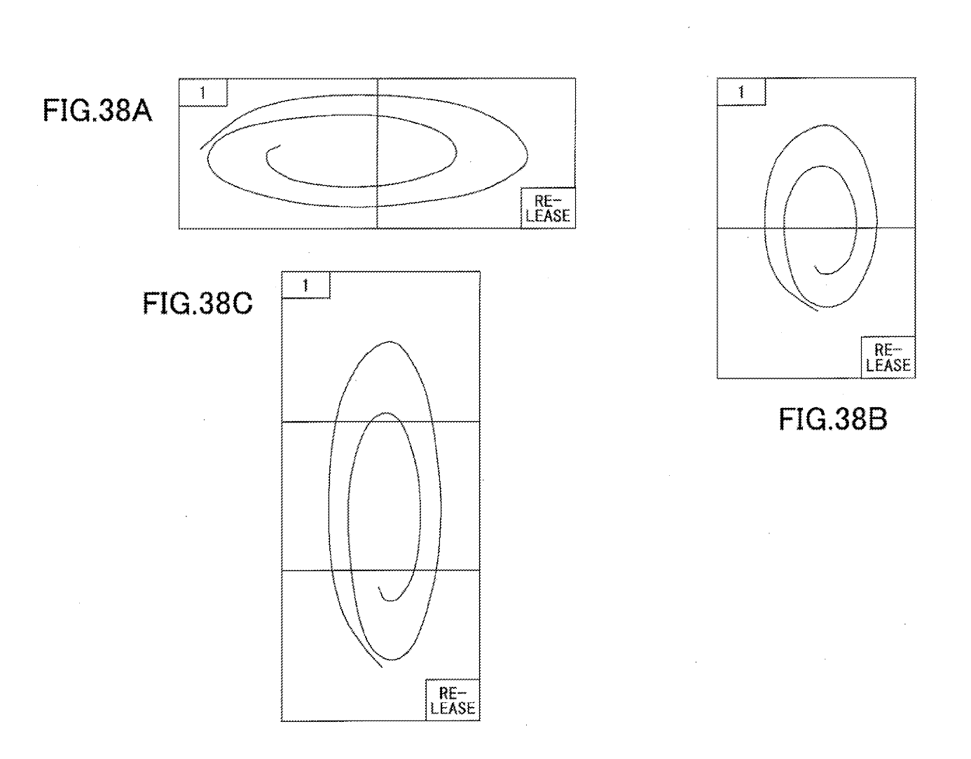

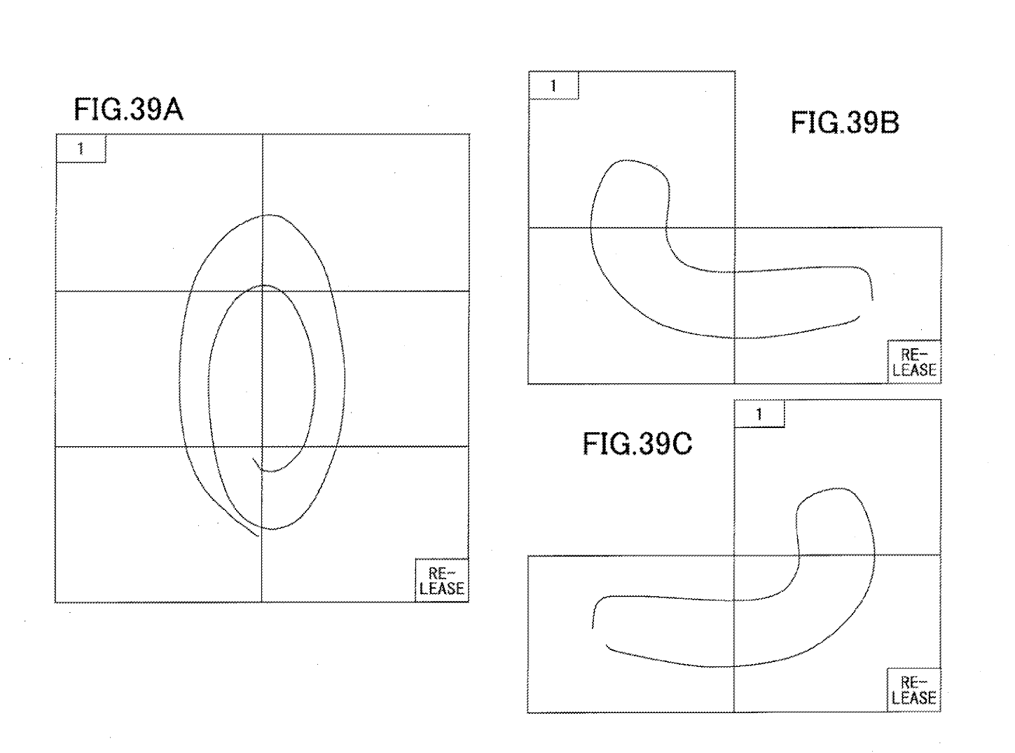

FIGS. 38A through 39C illustrate other examples of other arrangements of the terminal devices. FIGS. 38A through 38C are second diagrams of examples of other arrangements of the terminal devices. FIG. 38A illustrates an example where two terminal devices are horizontally arranged. FIG. 38B illustrates an example where two terminal devices are vertically arranged. FIG. 38C illustrates an example where three terminal devices are vertically arranged. In the arrangements of FIGS. 38A through 38C, the same process as that of the first embodiment can be used to group together the arranged terminal devices.

FIGS. 39A through 39C are third diagrams of examples of other arrangements of the terminal devices. FIG. 39A illustrates an example where six terminal devices are arranged in two columns and three rows. FIG. 39B illustrates an example where two out of three terminal devices are horizontally arranged, and the remaining one terminal device is vertically arranged with one of the horizontally arranged terminal devices. FIG. 39C illustrates an example where two out of three terminal devices are horizontally arranged, and the remaining one terminal device is vertically arranged with the other one of the horizontally arranged terminal devices. In the arrangements of FIGS. 39A through 39C, the same process as that of the first embodiment can be used to group together the arranged terminal devices.

Furthermore, in the above embodiments, the coordinate information is input into the display areas by handwriting drawn with a pointing device, etc.; however, the present invention is not so limited. The terminal devices of the above embodiments may be provided with a means for inputting coordinate information used for group determination.

According to an aspect of the present invention, terminal devices can be easily grouped together.

The present invention is not limited to the specific embodiments described herein, and variations and modifications may be made without departing from the scope of the present invention.

All examples and conditional language recited herein are intended for pedagogical purposes to aid the reader in understanding the invention and the concepts contributed by the inventors to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A server connected to a plurality of terminal devices, the server comprising:
a device ID (identification) storage unit configured to store device ID items for identifying the terminal devices;
an acquiring unit configured to acquire coordinate information that is input at the terminal devices identified by the device ID items and time information that is input;
a positional relationship determining unit configured to determine positional relationships between the terminal devices according to a sequence of coordinates that is input in a manner to cross over the terminal devices, based on the coordinate information and the time information; and
a group determining unit configured to extract, from determination results of the positional relationship determining unit, the device ID items identifying the terminal devices that are to be grouped together into a group.

2. The server according to claim 1, wherein
the coordinate information expresses the sequence of coordinates drawn into display areas of the terminal devices.

3. The server according to claim 2, wherein the group determining unit includes
a target coordinate point extracting unit configured to extract edge points located at edges of the display areas, based on the coordinate information and the time information,
a target coordinate point position determining unit configured to determine positions of the edge points located at the edges of the display areas,
a coordinate point determining unit configured to determine a pair of the edge points whose distance is to be calculated, from among the extracted edge points,
a distance calculating unit configured to calculate the distance between the edge points included in the pair determined by the coordinate point determining unit, and
a position determining unit configured to determine positions of the terminal devices, based on the calculated distance.

4. The server according to claim 3, wherein
the coordinate point determining unit is configured to determine, from among the extracted edge points, edge points whose time difference indicated by the time information is within a predetermined value, as the pair of the edge points whose distance is to be calculated.

5. The server according to claim 3, further comprising:
a group information managing unit configured to store group information in a group information database, the group information including the positions of the terminal devices determined by the position determining unit.

6. The server according to claim 5, wherein
the group information includes the device ID items of the terminal devices, an identifier of the group, and in-group-position information items indicating the positions of the terminal devices in the group.

7. The server according to claim 5, wherein the group determining unit includes
a direction determining unit configured to determine directions of the terminal devices based on direction information indicating the directions of the terminal devices input from the terminal devices, and
a coordinate converting unit configured to convert the coordinate information input from the terminal devices, based on the directions of the terminal devices determined by the direction determining unit.

8. The server according to claim 7, wherein
the direction determining unit is configured to set one of the terminal devices as a reference terminal device by referring to the group information, and determine the directions of the terminal devices other than the reference terminal device based on a direction of the reference terminal device.

9. The server according to claim 7, wherein
the group information database stores screen information indicating sizes and pixel numbers of the display areas of the terminal devices, and
the coordinate converting unit is configured to convert the coordinate information based on the screen information.

10. A terminal device comprising:
a display area;
a mode control unit configured to send a request to a server to switch to a grouping mode for performing a grouping process;
a communications unit configured to send, to the server, coordinate information of handwriting drawn into the display area and time information indicating a time when the coordinate information is acquired; and
a group information saving unit configured to receive, from the server, self device group information indicating that the grouping process has been performed, and save the self device group information.

11. The terminal device according to claim 10, further comprising:
a handwriting display unit configured to display the handwriting drawn into the display area until the self device group information is received, and erase the handwriting from the display area when the self device group information is received.

12. The terminal device according to claim 10, further comprising:
a time synchronization unit configured to synchronize a time according to a clock function of the server with a time of a clock function of the terminal device, when the terminal device is switched to the grouping mode by the mode control unit.

13. A grouping system comprising:
a plurality of terminal devices; and
a server connected to the terminal devices, wherein the server includes
a device ID (identification) storage unit configured to store device ID items for identifying the terminal devices,
an acquiring unit configured to acquire coordinate information that is input at the terminal devices identified by the device ID items and time information that is input,
a positional relationship determining unit configured to determine positional relationships between the terminal devices according to a sequence of coordinates that is input in a manner to cross over the terminal devices, based on the coordinate information and the time information, and
a group determining unit configured to extract, from determination results of the positional relationship determining unit, the device ID items identifying the terminal devices that are to be grouped together into a group, wherein each of the terminal devices includes
a communications unit configured to send, to the server, the coordinate information of the sequence of coordinates drawn into a display area of the terminal device and the time information indicating a time when the coordinate information is acquired, and
a group information saving unit configured to receive, from the server, self device group information indicating that a grouping process of grouping together the terminal devices into the group has been performed, and save the self device group information.

14. A method performed by a computer for grouping together a plurality of terminal devices, the method comprising:
referring to a device ID (identification) storage unit storing device ID items for identifying the terminal devices;
acquiring coordinate information that is input at the terminal devices identified by the device ID items and time information that is input;
determining positional relationships between the terminal devices according to a sequence of coordinates that is input in a manner to cross over the terminal devices, based on the coordinate information and the time information; and
extracting, from determination results obtained at the determining, the device ID items identifying the terminal devices that are to be grouped together into a group.

15. A method performed by a computer for sending a request to a server to switch to a grouping mode for performing a grouping process, the method comprising:
sending, to the server, coordinate information of a sequence of coordinates drawn into a display area and time information indicating a time when the coordinate information is acquired; and
receiving, from the server, self device group information indicating that the grouping process has been performed, and saving the self device group information.

16. A non-transitory computer-readable recording medium storing a grouping program that causes a computer to execute a method comprising:
referring to a device ID (identification) storage unit storing device ID items for identifying terminal devices;
acquiring coordinate information that is input at the terminal devices identified by the device ID items and time information that is input;
determining positional relationships between the terminal devices according to a sequence of coordinates that is input in a manner to cross over the terminal devices, based on the coordinate information and the time information; and
extracting, from determination results obtained at the determining, the device ID items identifying the terminal devices that are to be grouped together into a group.

17. A non-transitory computer-readable recording medium storing a grouping request program that causes a computer to execute a method comprising:
sending a request to a server to switch to a grouping mode for performing a grouping process;
sending, to the server, coordinate information of a sequence of coordinates drawn into a display area and time information indicating a time when the coordinate information is acquired; and
receiving, from the server, self device group information indicating that the grouping process has been performed, and saving the self device group information.
